(19) United States
(12) Patent Application Publication
(10) Pub. No.: US 2020/0056093 A1
(43) Pub. Date: Feb. 20, 2020

(54) LIQUID CRYSTAL DISPLAY DEVICE AND ELECTRONIC DEVICE

(71) Applicant: SHARP KABUSHIKI KAISHA, Sakai City, Osaka (JP)

(72) Inventors: MASANOBU MIZUSAKI, Sakai City, Osaka (JP); TSUYOSHI OKAZAKI, Sakai City, Osaka (JP)

(21) Appl. No.: 16/486,052

(22) PCT Filed: Feb. 20, 2018
(86) PCT No.: PCT/JP2018/005916

§ 371 Date: Aug. 14, 2019

(30) Foreign Application Priority Data
Feb. 20, 2017 (JP) 2017-029067

(51) Int. Cl. C09K 19/34; C09K 19/30; C09K 19/42; G02F 1/1339; G02F 1/1337

(52) U.S. Cl. CPC C09K 19/3483; C09K 19/3003; C09K 19/42; C09K 2019/301; G02F 1/133719; C09K 2019/3004; G02F 1/1339

(57) ABSTRACT

A liquid crystal display device includes a pair of substrates, a negative liquid crystal layer held between the pair of substrates, a seal portion held between the pair of substrates and disposed around the liquid crystal layer, and a pair of alignment layers each of which is disposed on a surface, adjacent to the liquid crystal layer, of a corresponding one of the substrates. The negative liquid crystal layer includes a liquid crystal composition including a compound having a functional group represented by the formula (A) below, the seal portion includes a radical polymerization initiator, the alignment layers include a polymer including polyimide, the polyimide is prepared from polyamic acid as a precursor, and the imidization ratio of the polyimide is not less than 60% with respect to the whole polymer.

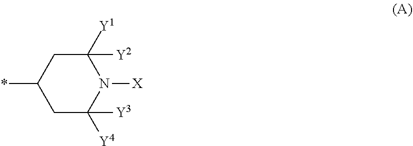

(where X: oxygen radical, hydroxyl group, C₁₋₂₀ linear alkyl group, or C₃₋₂₀ branched alkyl group, Y1 to Y4: C₁₋₄ linear alkyl group or C₃₋₄ branched alkyl group)

### TECHNICAL FIELD

Some aspects of the present invention relate to liquid crystal display devices and electronic devices.

This application claims priority from Japanese Patent Application No. 2017-029067 filed on Feb. 20, 2017, the entire contents of which are incorporated herein by reference.

### BACKGROUND ART

Liquid crystal display devices are conventionally used widely as displays in devices such as portable electronic devices including smartphones, televisions, and personal computers.

In recent years, liquid crystal display devices which satisfy both low power consumption and good image quality are demanded.

Patent Literature 1 describes a liquid crystal composition including a negative liquid crystal material and a radical scavenger. When used in a liquid crystal layer of a liquid crystal display device, the liquid crystal composition of Patent Literature 1 can offer an improved VHR (voltage holding ratio) of the liquid crystal display device. The VHR is widely used as an indicator in the reduction of power consumption of liquid crystal display devices.

### CITATION LIST

### Patent Literature

PTL 1: Japanese Unexamined Patent Application Publication No. 2012-224632

### SUMMARY OF INVENTION

### Technical Problem

One of the applications where liquid crystal display devices are used is compact electronic devices such as smartphones and car navigation systems. Liquid crystal display devices usable in display sections of these devices are required to consume less power so that the devices can be driven for a long time. It is needless to mention that liquid crystal display devices are required to suffer no or negligible loss of image quality during use.

An aspect of the present invention has been made in light of the circumstances discussed above, and therefore has an object of providing a liquid crystal display device that concurrently attains good image quality and low power consumption. Another object is to provide an electronic device capable of achieving good image quality and low power consumption concurrently.

### Solution to Problem

A liquid crystal display device includes a pair of substrates, a liquid crystal layer held between the pair of substrates, and a seal portion held between the pair of substrates and disposed around the liquid crystal layer. The substrates usually have, on their surfaces adjacent to the liquid crystal layer, an alignment layer that aligns a liquid crystal composition present in the liquid crystal layer to a predetermined direction. Polyimides obtained by polymerizing polyamic acid are known as materials for alignment layers.

Studies conducted by the present inventors have revealed that when the liquid crystal composition described in Patent Literature 1 is used in combination with alignment layers made of polyimide obtained by the polymerization of polyamic acid, the liquid crystal display device can suffer an image quality deterioration which is caused by the radical scavenger contained in the liquid crystal composition.

In the liquid crystal display device having the above combination, the radical scavenger present in the liquid crystal composition can undergo thermal reaction with the carboxylic acid in the polyamic acid backbone that forms the alignment layers, thus producing ionic impurities. Such impurities lower the resistivity of the liquid crystal layer. Consequently, the liquid crystal display device may have a reduced VHR and may consume more power.

The reduction in VHR manifests as various deteriorations in image quality such as screen flickers, image sticking, and spots on the screens of liquid crystal display devices.

Portable electronic devices are sometimes used in hot environments such as outdoors or in vehicles in summer and are therefore probably more susceptible to the manifestation of image quality deteriorations such as image sticking and spots.

The present inventors have conducted extensive studies on these problems, and have completed the present invention as a result.

To solve the above problems, an embodiment of the present invention provides a liquid crystal display device including a pair of substrates, a negative liquid crystal layer held between the pair of substrates, a seal portion held between the pair of substrates and disposed around the liquid crystal layer, and a pair of alignment layers each of which is disposed on a surface, adjacent to the liquid crystal layer, of a corresponding one of the substrates, in which the negative liquid crystal layer includes a liquid crystal composition including a compound having a functional group represented by formula (A) below, the seal portion includes a radical polymerization initiator, the alignment layers include a polymer including polyimide, the polyimide is prepared from polyamic acid as a precursor, and an imidization ratio of polyimide is not less than 60% with respect to the whole polymer.

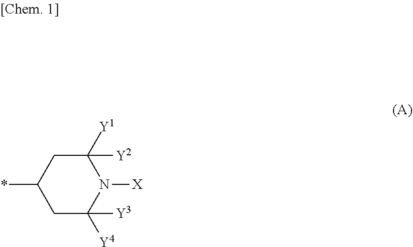

(where X denotes an oxygen radical (O.), a hydroxyl group, a C₁₋₂₀ linear alkyl group, or a C₃₋₂₀ branched alkyl group, and Y1 to Y4 each independently denote a C₁₋₄ linear alkyl group or a C₃₋₄ branched alkyl group.)

Another embodiment of the present invention provides a liquid crystal display device including a pair of substrates, a negative liquid crystal layer held between the pair of substrates, a seal portion held between the pair of substrates and disposed around the liquid crystal layer, and a pair of alignment layers each of which is disposed on a surface, adjacent to the negative liquid crystal layer, of a corresponding one of the substrates, in which the liquid crystal layer includes a liquid crystal composition including a compound having a functional group represented by formula (A) below, the seal portion includes a radical polymerization initiator, the alignment layers each include a lower alignment layer including a polymer including polyimide and an upper alignment layer disposed in contact with the lower alignment layer to cover the surface of the lower alignment layer, the polyimide is prepared from polyamic acid as a precursor, the upper alignment layer includes polysiloxane, and a proportion of the polysiloxane is not less than 10 mass % and not more than 30 mass % of an entirety of the alignment layers.

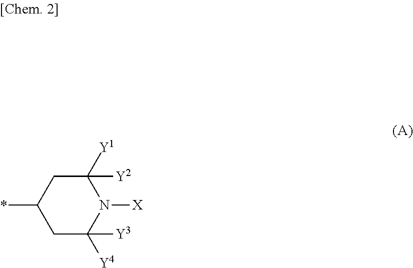

(where X denotes an oxygen radical (O.), a hydroxyl group, a C₁₋₂₀ linear alkyl group, or a C₃₋₂₀ branched alkyl group, and Y1 to Y4 each independently denote a C₁₋₄ linear alkyl group or a C₃₋₄ branched alkyl group.)

Another embodiment of the present invention provides a liquid crystal display device including a pair of substrates, a negative liquid crystal layer held between the pair of substrates, a seal portion held between the pair of substrates and disposed around the liquid crystal layer, and a pair of alignment layers each of which is disposed on a surface, adjacent to the liquid crystal layer, of a corresponding one of the substrates, in which the liquid crystal layer includes a liquid crystal composition including a compound having a functional group represented by formula (A) below, the seal portion includes a radical polymerization initiator, the alignment layers each include a lower alignment layer including a polymer including polyimide, and a surface treatment layer disposed in contact with the lower alignment layer to cover the surface of the lower alignment layer, the polyimide is prepared from polyamic acid as a precursor, the surface treatment layer includes a silane coupling agent, and the silane coupling agent has a functional group forming a covalent bond with a carboxyl group present in the polyamic acid.

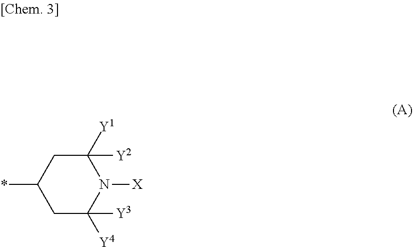

(where X denotes an oxygen radical (O.), a hydroxyl group, a C₁₋₂₀ linear alkyl group, or a C₃₋₂₀ branched alkyl group, and Y1 to Y4 each independently denote a C₁₋₄ linear alkyl group or a C₃₋₄ branched alkyl group.)

In an embodiment of the present invention, the silane coupling agent may be a compound represented by formula (D) below.

[Chem. 4]

R₃Si—Z (D)

(where R denotes a chlorine atom or a C₁₋₄ alkoxy group, and Z denotes a substituent represented by any of formulae (D1) to (D19) below.)

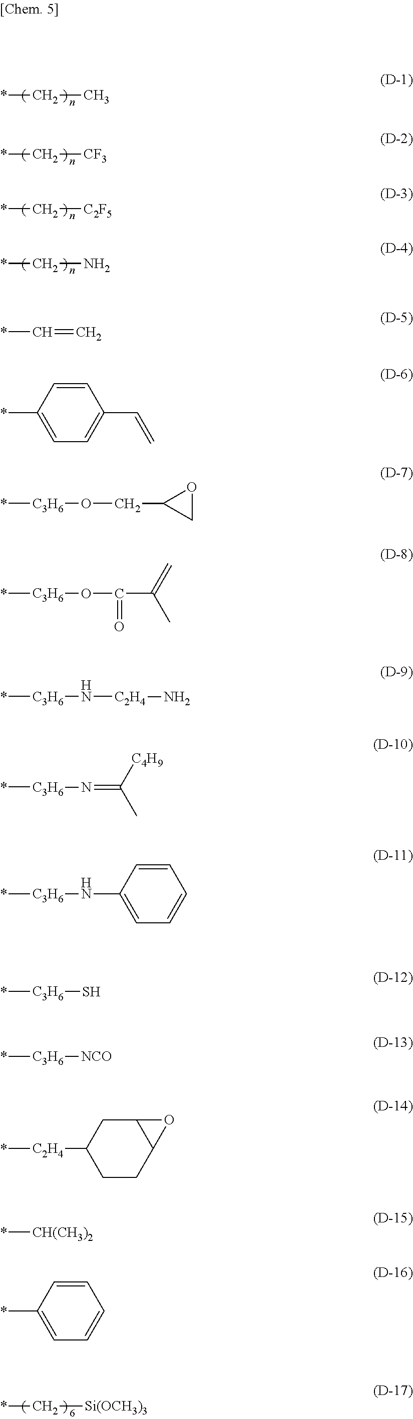

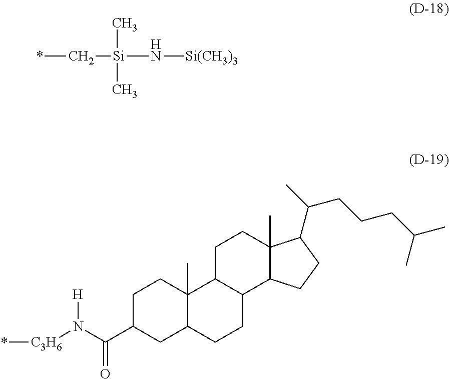

(where n denotes an integer of 1 to 18.)

In an embodiment of the present invention, the silane coupling agent may be a compound represented by formula (109) below.

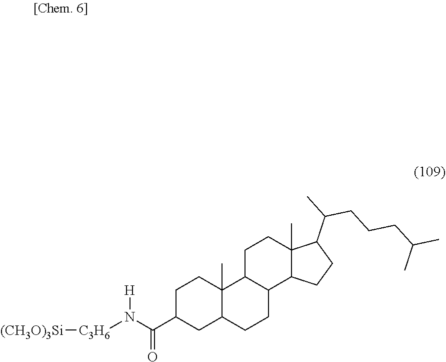

In an embodiment of the present invention, an imidization ratio of polyimide may be not less than 45% with respect to the whole polymer.

In an embodiment of the present invention, a content of the compound in the liquid crystal layer may be not more than 1000 ppm.

In an embodiment of the present invention, the liquid crystal composition may include a liquid crystal molecule having a functional group represented by formula (B) below.

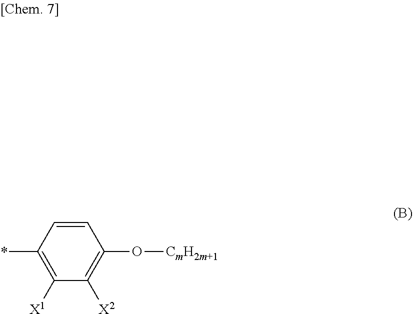

(where X1 and X2 each independently denote a hydrogen atom, a fluorine atom, and m denotes an integer of 1 to 18.)

In an embodiment of the present invention, the liquid crystal composition may include at least one compound selected from the group consisting of formulae (C1) to (C4) below.

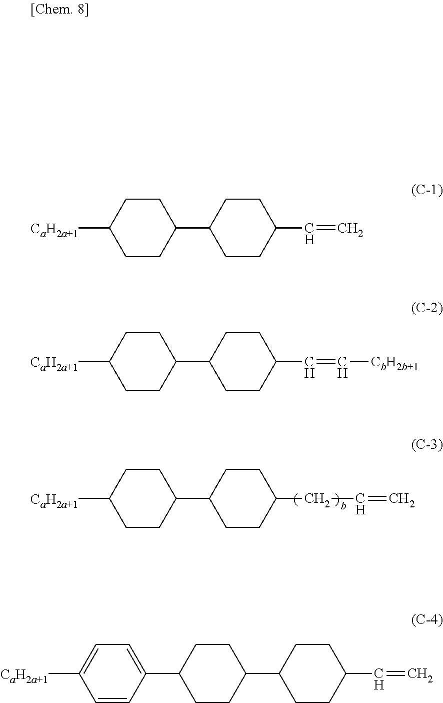

(where a and b each independently denote an integer of 1 to 6.)

In an embodiment of the present invention, the radical polymerization initiator may be decomposed by absorbing light with a wavelength of not less than 350 nm.

In an embodiment of the present invention, the radical polymerization initiator may have a thermal decomposition temperature of not less than 50° C.

Another embodiment of the present invention provides an electronic device including the liquid crystal display device described above.

### Advantageous Effects of Invention

The liquid crystal display devices according to an aspect of the present invention concurrently attain good image quality and low power consumption.

### BRIEF DESCRIPTION OF DRAWINGS

FIG. 1 is a sectional view schematically illustrating a liquid crystal display device of the first embodiment.

FIG. 2 is a sectional view schematically illustrating a liquid crystal display device of the second embodiment.

FIG. 3 is a sectional view schematically illustrating a liquid crystal display device of the third embodiment.

FIG. 4 is a schematic view illustrating an electronic device of the fourth embodiment.

FIG. 5 is a schematic view illustrating an electronic device of the fourth embodiment.

FIG. 6 is a schematic view illustrating an electronic device of the fourth embodiment.

FIG. 7 is a schematic view illustrating an electronic device of the fourth embodiment.

### DESCRIPTION OF EMBODIMENTS

### First Embodiment

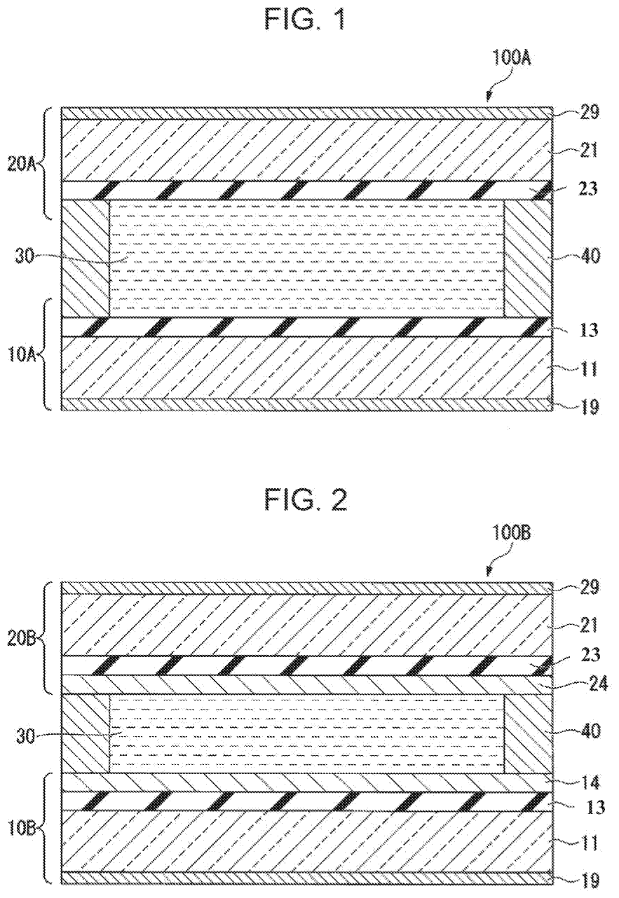

A liquid crystal display device of the first embodiment of the present invention is described hereinbelow with reference to FIG. 1. In all the drawings discussed below, the configuration such as sizes and proportions of elements may be changed appropriately to make the drawings more legible.

### <Liquid Crystal Display Device>

FIG. 1 is a sectional view schematically illustrating a liquid crystal display device of the present embodiment. As illustrated, the liquid crystal display device 100A of the present embodiment includes a device substrate 10A, a counter substrate 20A, a liquid crystal layer 30, and a seal portion 40. The device substrate 10A and the counter substrate 20A correspond to the “pair of substrates” in an aspect of the present invention.

The liquid crystal display device 100A of the present embodiment adopts a configuration for VA (vertical alignment) ECB mode. That is, the liquid crystal display device 100A is a VA liquid crystal display device. The liquid crystal display devices of the embodiments described in the present invention are not limited to the VA type, and may be applied to a variety of alignment modes. Some example alignment modes that are applicable to the liquid crystal display devices are TN (twisted nematic), STN (super-twisted nematic), IPS (in plane switching), FFS (fringe field switching), and VA.

### (Device Substrate)

The device substrate 10A includes a TFT substrate 11, a first alignment layer 12 disposed on the surface of the TFT substrate 11 adjacent to the liquid crystal layer 30, and a first polarizer 19 disposed on the surface of the TFT substrate 11 opposite to the liquid crystal layer 30.

The TFT substrate 11 has a driving TFT device that is not shown. The drain electrode, the gate electrode, and the source electrode of the driving TFT device are electrically connected to a pixel electrode, a gate bus line, and a source bus line, respectively. The pixels are electrically connected to one another via the electric wires of the source bus lines and the gate bus lines.

The components in the TFT substrate 11 may be those made of known materials. The semiconductor layer in the driving TFT is preferably made of IGZO (a quaternary mixed crystal semiconductor material including indium (In), gallium (Ga), zinc (Zn), and oxygen (O)). When IGZO is used as the component of the semiconductor layer, the semiconductor layer that is obtained has a low off-leakage current, and thus the leakage of charges is reduced. Thus, it becomes possible to extend the idle period after the application of voltage to the liquid crystal layer. As a result, the liquid crystal display device can display images with a reduced number of voltage application and thus consumes less power.

The TFT substrate 11 of the liquid crystal display device may be of active matrix system in which each pixel has a driving TFT, or may be of simple matrix system where the pixels have no driving TFTs.

The first alignment layer 12 is a vertical alignment layer made of a polymer including polyimide. For example, the first alignment layer 12 is a alignment layer.

The polyimide that forms the first alignment layer 12 is obtained by intramolecular cyclization (imidization) of polyamic acid as a precursor.

Specifically, the polyamic acid that is the precursor of the polyimide may be exemplified by the following.

Examples of the precursors having a polyamic acid backbone include those which have a polyamic acid backbone represented by the formula (10) below and in which the unit X contained in the polyamic acid is represented by any of the formulae (X-1) to (X-11) below, and those which have a polyamic acid backbone represented by the formula (10) below and in which the unit E contained in the polyamic acid is represented by any of the formulae (E-1) to (E-16) below. The unit X has four bonding sites as illustrated. The four bonding sites accept two carbonyl groups that are bonded when the unit is introduced to the position X in the formula (10) below and also accept two carboxyl groups that are not shown.

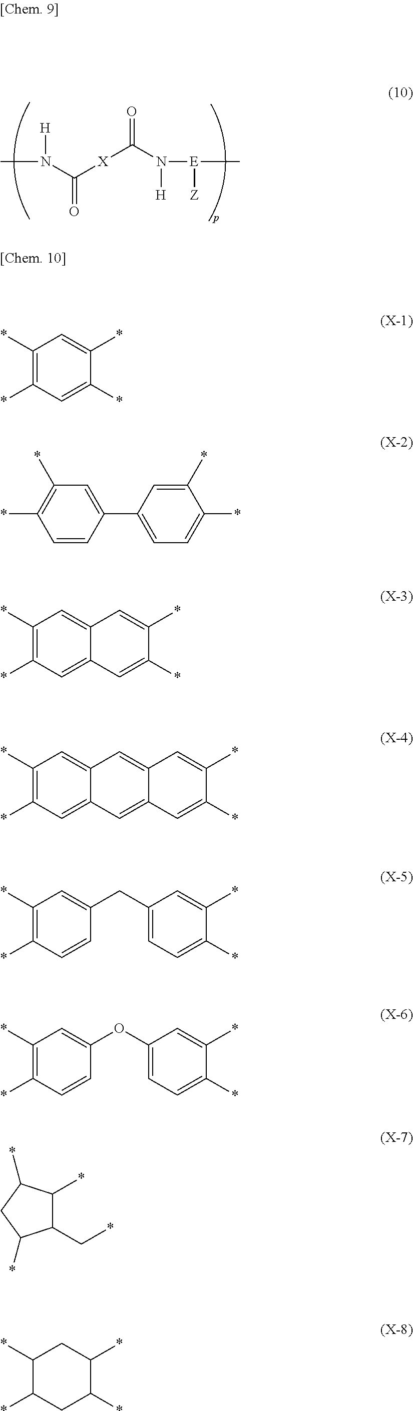

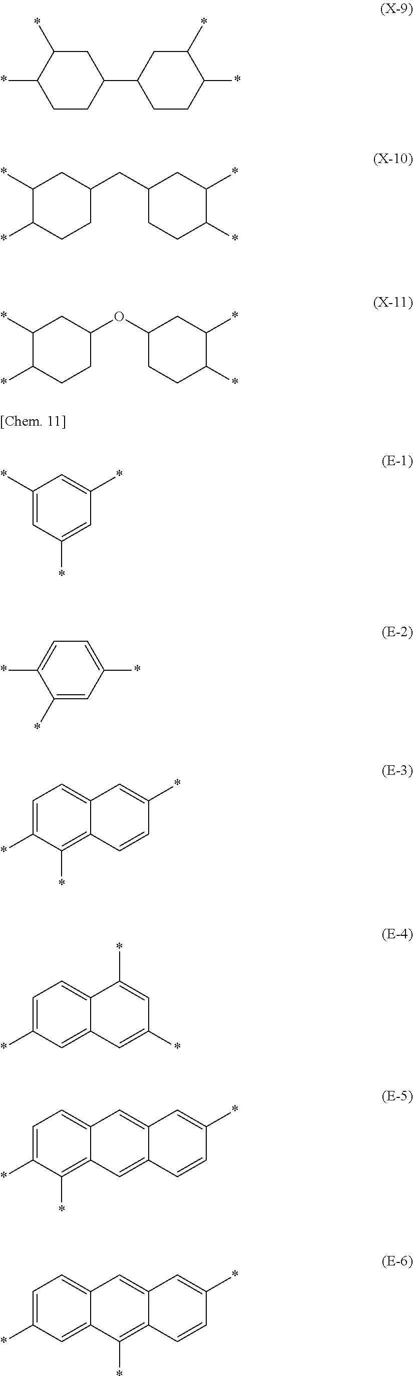

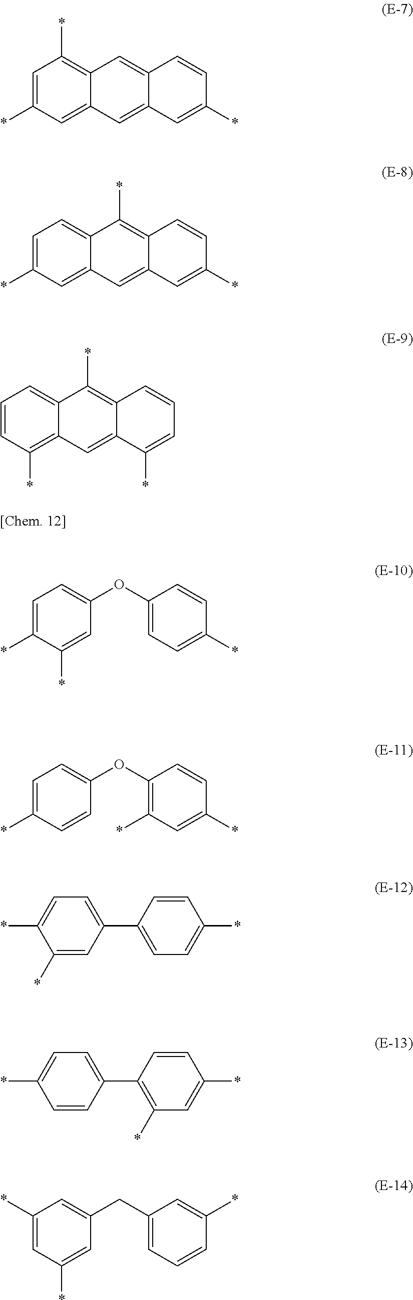

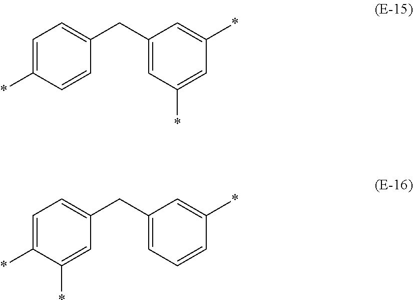 [SMILES: *c1ccc(Cc2cc(*)cc(*)c2)cc1 ; *c1cccc(Cc2ccc(*)c(*)c2)c1]

Examples of the precursors having a polyamic acid backbone further include those which have a photofunctional group in any position in the unit X and the unit E. Examples of the photofunctional groups which can be present in the units X include those of the formulae (X-101) to (X-105) below. Examples of the photofunctional groups which can be present in the units E include those of the formulae (E-101) to (E-108) below.

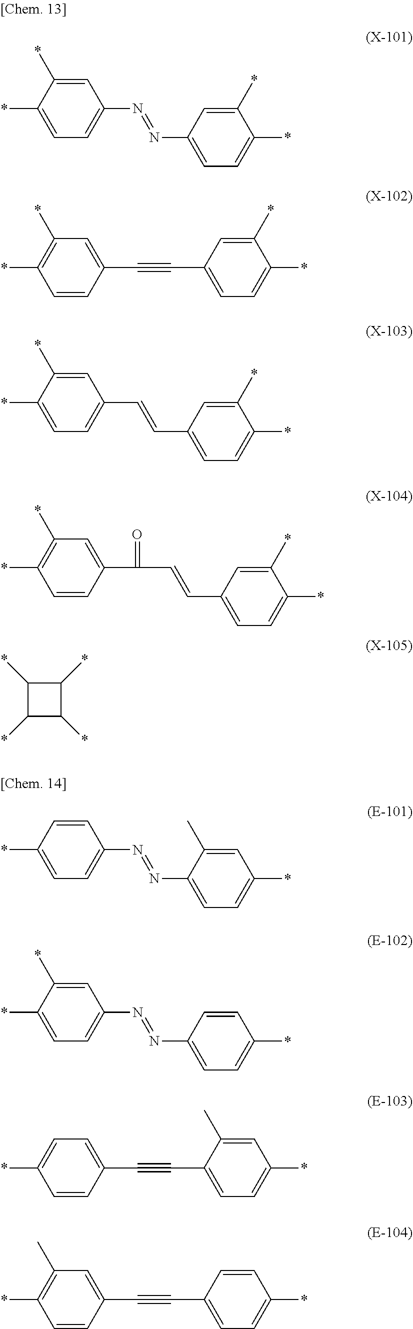

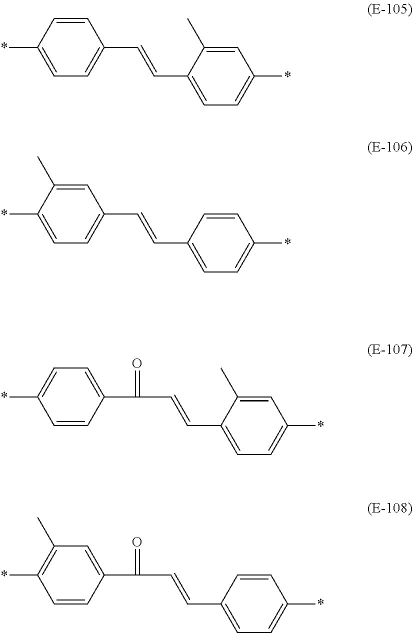 [SMILES: *c1ccc(/C=C/c2ccc(*)cc2C)cc1 ; *c1ccc(/C=C/c2ccc(*)c(C)c2)cc1 ; *c1ccc(C(=O)/C=C/c2ccc(*)cc2C)cc1 ; *c1ccc(/C=C/C(=O)c2ccc(*)c(C)c2)cc1]

Where the alignment layer is a vertical alignment layer as is the case in the present embodiment, the unit Z contained in the polyamic acid may be, for example, any of the formulae (Z-1) to (Z-8) below.

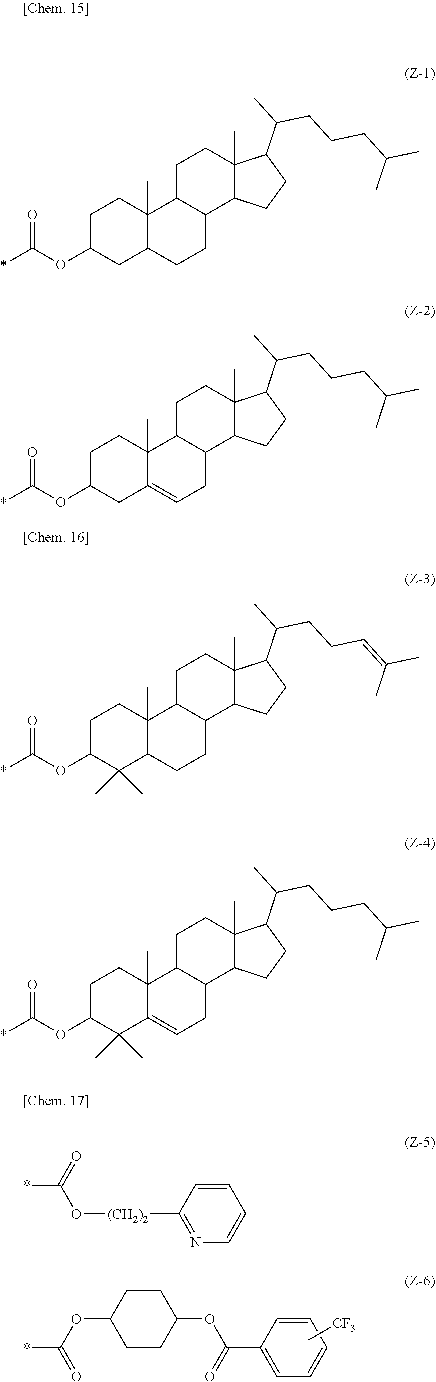

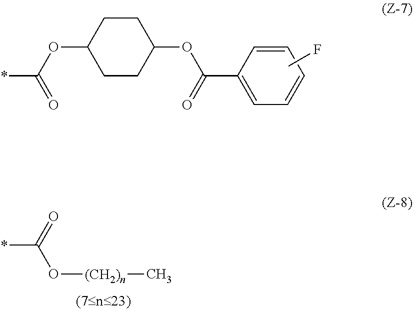

When the present invention is applied to a liquid crystal display device having horizontal alignment layers, the unit Z that is contained in the polyimide (polyamic acid) forming the horizontal alignment layers may be, for example, any of a hydrogen atom, a C₁₋₄ alkyl group, a C₃₋₈ cycloalkyl group, or a C₄₋₈ aromatic group. The alkyl group, the cycloalkyl group, and the aromatic group may be substituted with a fluorine atom or a chlorine atom in place of one or more hydrogen atoms.

The first polarizer 19 may be of known configuration.

### (Counter Substrate)

For example, the counter substrate 20A includes a color filter substrate 21, a second alignment layer 22 disposed on the surface of the color filter substrate 21 adjacent to the liquid crystal layer 30, and a second polarizer 29 disposed on the surface of the color filter substrate 21 opposite to the liquid crystal layer 30.

For example, the color filter substrate 21 includes a red color filter layer that absorbs part of incident light and transmits red light, a green color filter layer that absorbs part of incident light and transmits green light, and a blue color filter layer that absorbs part of incident light and transmits blue light.

Further, the color filter substrate 21 may have an overcoating layer which covers the surface to planarize the substrate surface and to prevent leaching of color components from the color filter layers.

The second alignment layer 22 is an alignment layer made of a polymer including polyimide. For example, the second alignment layer 22 is a vertical alignment layer.

The polyimide that forms the second alignment layer 22 is obtained by intramolecular cyclization (imidization) of polyamic acid as a precursor. Examples of the materials for forming the second alignment layer 22 include those materials for forming the first alignment layer 12.

The second polarizer 29 may be of known configuration. For example, the first polarizer 19 and the second polarizer 29 may be set in the crossed Nicols configuration.

### (Liquid Crystal Layer)

The liquid crystal layer 30 includes a liquid crystal composition that includes a liquid crystalline material containing liquid crystal molecules (a liquid crystal material), and a radical scavenger.

The liquid crystal material may be composed solely of liquid crystal molecules that exhibit liquid crystallinity by themselves. Alternatively, liquid crystal molecules that exhibit liquid crystallinity by themselves may be mixed with an organic compound that does not exhibit liquid crystallinity by itself to form a liquid crystalline composition. The liquid crystal material that is used is a negative liquid crystal having negative dielectric anisotropy.

The liquid crystal material preferably includes a liquid crystal molecule having a functional group represented by the formula (B) below.

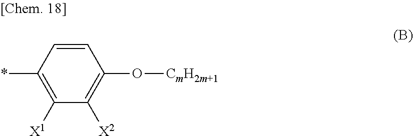

(where X1 and X2 each independently denote a hydrogen atom, a fluorine atom.

m denotes an integer of 1 to 18.)

Examples of the liquid crystal molecules which may be used include the formulae (B-1) to (B-5) below.

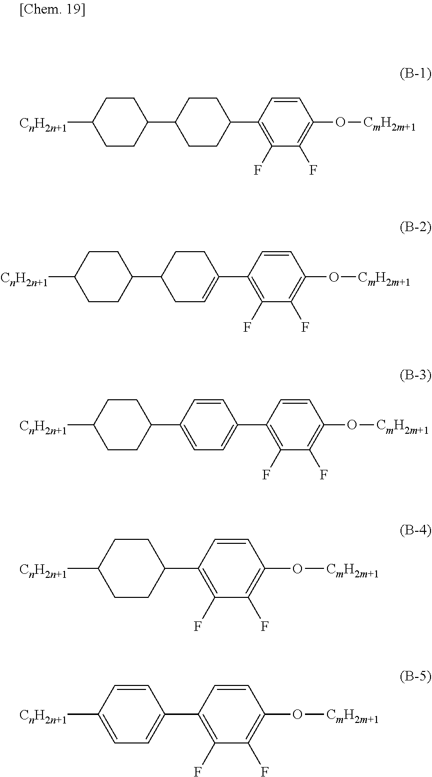

(where m denotes an integer of 1 to 18.)

The liquid crystal material preferably includes at least one compound (alkenyl compound) selected from the group consisting of the formulae (C-1) to (C-4) below. The liquid crystal material including such an alkenyl compound attains enhanced response speed. Thus, when the liquid crystal material including such an alkenyl compound is used in the liquid crystal layer, the liquid crystal display device can attain high image quality.

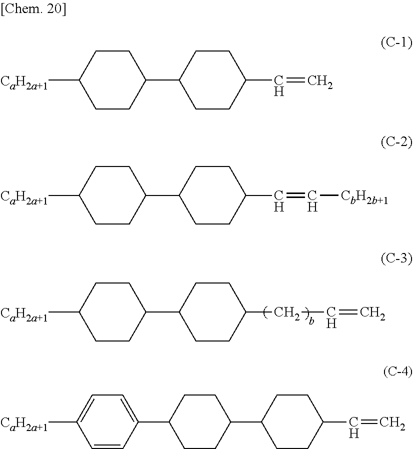

(where a and b each independently denote an integer of 1 to 6.)

Examples of such compounds include one represented by the formula (C-10) below. The compound of the formula (C-10) below corresponds to the compound of the above formula (C-1) in which a=3.

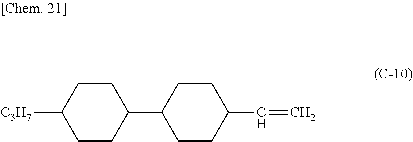

### (Radical Scavenger)

The liquid crystal composition includes a compound having a functional group represented by the formula (A) below (the compound being referred to as the radical scavenger hereinafter).

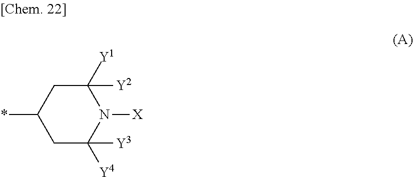

(where X denotes an oxygen radical (O.), a hydroxyl group, a C₁₋₂₀ linear alkyl group, or a C₃₋₂₀ branched alkyl group.

Y1 to Y4 each independently denote a C₁₋₄ linear alkyl group or a C₃₋₄ branched alkyl group.)

The liquid crystal composition including the above radical scavenger offers a high VHR (voltage holding ratio) of the liquid crystal display device.

Examples of the radical scavengers include the formulae (A-1) to (A-17) below.

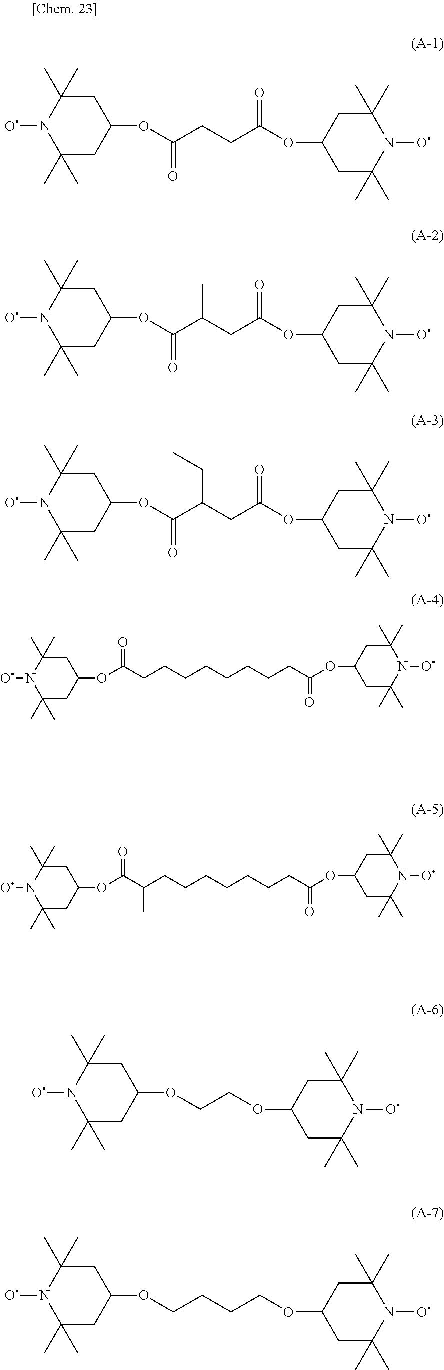

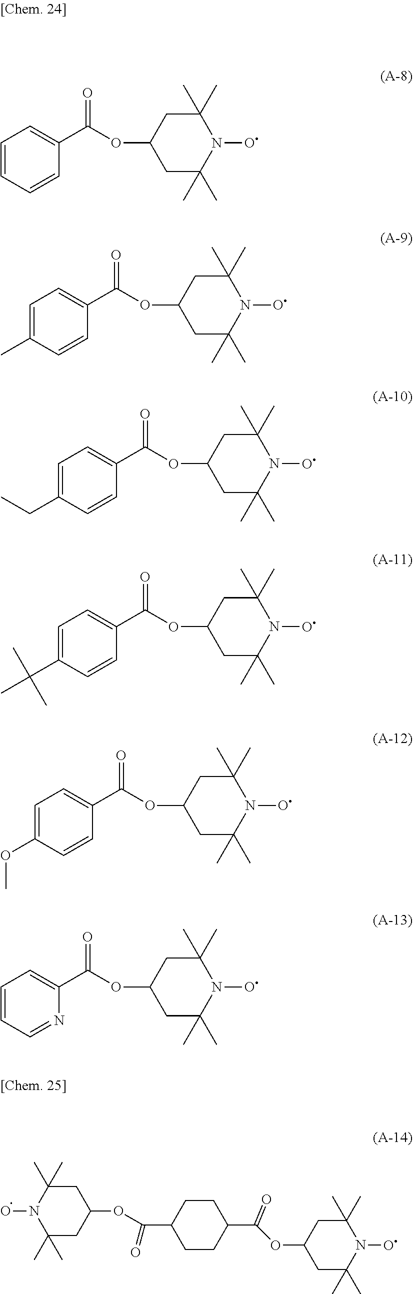

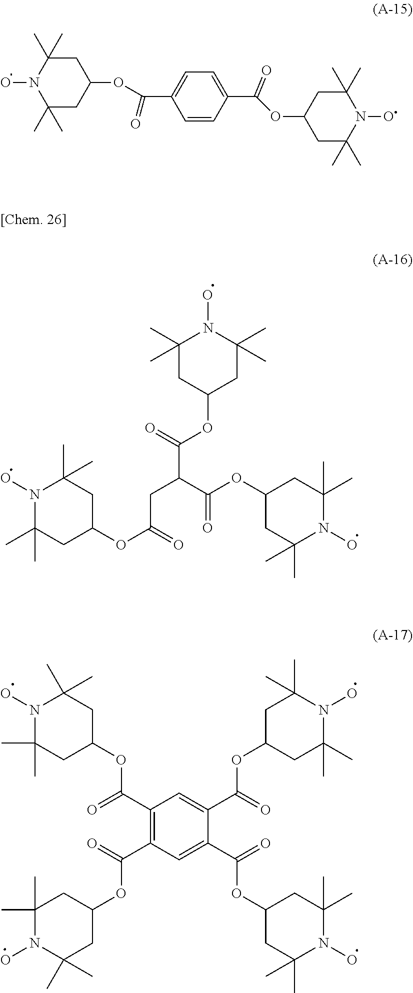

The content of the radical scavenger in the liquid crystal composition is preferably more than 0 ppm and not more than 1000 ppm. The radical scavenger has a charged radical portion in itself or can easily cause a radical portion. Thus, a drop in voltage holding ratio caused by the radical scavenger can be suppressed by limiting the content of the radical scavenger to not more than 1000 ppm.

The content of the radical scavenger in the liquid crystal composition may be calculated by liquid chromatography analysis. When the radical scavenger is a stable radical, that is, when X in the above formula (A) is an oxygen radical (O.), the content may be calculated based on the ESR peak intensity.

In the absence of voltage application, the liquid crystal composition is aligned in accordance with the anchoring energy of the first alignment layer 12 and the second alignment layer 22.

The nematic-isotropic phase transition temperature of the liquid crystal composition is preferably set higher than temperatures expected in the environments where the liquid crystal display device is used. When, for example, there is a possibility where an electronic device having the liquid crystal display device of the present embodiment is exposed to an environment temperature of 60° C., it is recommended that the phase transition temperature of the liquid crystal composition is controlled to be higher than 80° C. The liquid crystal composition having such a phase transition temperature offers high reliability of the liquid crystal display device.

The phase transition temperature of the liquid crystal composition may be determined by (1) gradually heating a liquid crystal cell set on a Mettler plate (a plate with a heater) and tracking changes in phase state by temperature or (2) DSC (differential scanning calorimetry).

### (Seal Portion)

The seal portion 40 is held between the device substrate 10A and the counter substrate 20A and is disposed around the liquid crystal layer 30. The seal portion 40 is in contact with the liquid crystal composition forming the liquid crystal layer 30 and prevents leakage of the liquid crystal composition.

The seal portion 40 is made of a curable resin composition. The curable resin composition is not particularly limited as long as having a UV reactive functional group and a thermally reactive functional group. A curable resin composition having either or both of a (meth)acryloyl group and an epoxy group is advantageous in that the composition used as a one-drop-filling (ODF) sealant is quickly cured and exhibits good adhesion.

Examples of such curable resin compositions include (meth)acrylates and epoxy resins. These resins may be used singly, or two or more thereof may be used in combination. In the present specification, the term (meth)acrylic means acrylic or methacrylic.

The (meth)acrylates are not particularly limited, and examples thereof include urethane (meth)acrylates having a urethane bond, and epoxy (meth)acrylates derived from a glycidyl compound and (meth)acrylic acid.

The urethane (meth)acrylates are not particularly limited, and examples thereof include derivatives formed between a diisocyanate such as isophorone diisocyanate and a reactive compound capable of addition reacting with isocyanates, such as acrylic acid or hydroxyethyl acrylate. Such derivatives may be chain-extended by a chain extender such as caprolactone or polyol. Some commercial products are, for example, U-122P, U-340P, U-4HA, and U-1084A (all manufactured by Shin-Nakamura Chemical Co., Ltd.); and KRM7595, KRM7610 and KRM7619 (all manufactured by DAICEL UCB).

The epoxy (meth)acrylates are not particularly limited, and examples thereof include epoxy (meth)acrylates derived from (meth)acrylic acid and an epoxy resin such as bisphenol A epoxy resin or propylene glycol diglycidyl ether. Some commercial products are, for example, EA-1020, EA-6320, and EA-5520 (all manufactured by Shin-Nakamura Chemical Co., Ltd.); and Epoxy Ester 70PA and Epoxy Ester 3002A (all manufactured by Kyoeisha Chemical Co., Ltd.).

Examples of the (meth)acrylates further include methyl methacrylate, tetrahydrofurfuryl methacrylate, benzyl methacrylate, isobornyl methacrylate, 2-hydroxyethyl methacrylate, glycidyl methacrylate, (poly)ethylene glycol dimethacrylate, 1,4-butanediol dimethacrylate, 1,6-hexanediol dimethacrylate, trimethylolpropane triacrylate, pentaerythritol triacrylate, and glycerin dimethacrylate.

Examples of the epoxy resins include phenol novolac epoxy resins, cresol novolac epoxy resins, biphenyl novolac epoxy resins, trisphenol novolac epoxy resins, dicyclopentadiene novolac epoxy resins, bisphenol A epoxy resins, bisphenol F epoxy resins, 2,2′-diallyl bisphenol A epoxy resins, bisphenol S epoxy resins, hydrogenated bisphenol A epoxy resins, propylene oxide-added bisphenol A epoxy resins, biphenyl epoxy resins, naphthalene epoxy resins, resorcinol epoxy resins, and glycidyl amines.

Examples of commercially available phenyl novolac epoxy resins include NC-3000S (manufactured by Nippon Kayaku Co., Ltd.).

Examples of commercially available trisphenol novolac epoxy resins include EPPN-501H (all manufactured by Nippon Kayaku Co., Ltd.).

Examples of commercially available dicyclopentadiene novolac epoxy resins include NC-7000L (manufactured by Nippon Kayaku Co., Ltd.).

Examples of commercially available bisphenol A epoxy resins include EPICLON 840S and EPICLON 850CRP (all manufactured by DIC CORPORATION).

Examples of commercially available bisphenol F epoxy resins include EPIKOTE 807 (manufactured by Japan Epoxy Resins Co., Ltd.) and EPICLON 830 (manufactured by DIC CORPORATION).

Examples of commercially available 2,2′-diallyl bisphenol A epoxy resins include RE310NM (manufactured by Nippon Kayaku Co., Ltd.).

Examples of commercially available hydrogenated bisphenol epoxy resins include EPICLON 7015 (manufactured by DIC CORPORATION).

Examples of commercially available propylene oxide-added bisphenol A epoxy resins include Epoxy Ester 3002A (manufactured by Kyoeisha Chemical Co., Ltd.).

Examples of commercially available biphenyl epoxy resins include EPIKOTE YX-4000H and YL-6121H (all manufactured by Japan Epoxy Resins Co., Ltd.).

Examples of commercially available naphthalene epoxy resins include EPICLON HP-4032 (manufactured by DIC CORPORATION).

Examples of commercially available resorcinol epoxy resins include Denacol EX-201 (manufactured by Nagase ChemteX Corporation).

Examples of the glycidyl amines include EPICLON 430 (manufactured by DIC CORPORATION) and EPIKOTE 630 (manufactured by Japan Epoxy Resins Co., Ltd.).

As the curable resin composition, an epoxy/(meth)acrylic resin having at least one (meth)acrylate group and at least one epoxy group in the molecule may be suitably used.

Examples of the epoxy/(meth)acrylic resins include compounds obtained by reacting some epoxy groups of an epoxy resin with (meth)acrylic acid in accordance with a common method in the presence of a basic catalyst, compounds obtained by reacting 1 mol of a bifunctional or polyfunctional isocyanate with ½ mol of a hydroxyl-containing (meth)acrylic monomer and subsequently with ½ mol of glycidol, and compounds obtained by reacting an isocyanate-containing (meth)acrylate with glycidol. Some commercially available epoxy/(meth)acrylic resins are, for example, UVAC 1561 (manufactured by DAICEL UCB).

### (Radical Polymerization Initiator)

The curable resin composition includes a radical polymerization initiator. The radical polymerization initiator may be photo-decomposable or thermally decomposable. To facilitate the sealing of the liquid crystal layer, it is preferable to use a photo-decomposable radical polymerization initiator (a photopolymerization initiator).

The photopolymerization initiator is not particularly limited as long as the initiator can induce the polymerization of the curable resin composition by being irradiated with UV. A photopolymerization initiator having a hydrogen-bonding functional group in the molecule is preferable in order to resist dissolution into the liquid crystal composition. Examples of such functional groups include OH group, NH₂ group, NHR group (R is an aromatic or aliphatic hydrocarbon, or a derivative thereof), COOH group, CONH₂ group, NHOH group, and groups having a residue of a bond such as NHCO bond, NH bond, CONHCO bond, or NH—NH bond in the molecule.

A photopolymerization initiator which is decomposed by absorbing light with a wavelength of 350 nm or more may be suitably used. The use of such an initiator facilitates the photocuring reaction and thus leads to enhanced productivity.

The polymerization initiator is preferably one having a thermal decomposition temperature of not less than 50° C. The thermal decomposition temperature of the polymerization initiator is preferably not more than 230° C. By using a polymerization initiator with a thermal decomposition temperature of not less than 50° C., the curing of the sealant can be performed at temperatures which can suppress production of a nitroso compound (ion) by the thermal reaction between the carboxyl group in the polyamic acid and the radical scavenger. By virtue of the thermal decomposition temperature of the polymerization initiator being not more than 230° C., the thermal curing of the sealant can take place while suppressing side reactions which cause the decomposition of the alignment layers and the liquid crystal material.

Examples of such photopolymerization initiators include the formulae (I-1) to (I-6) below.

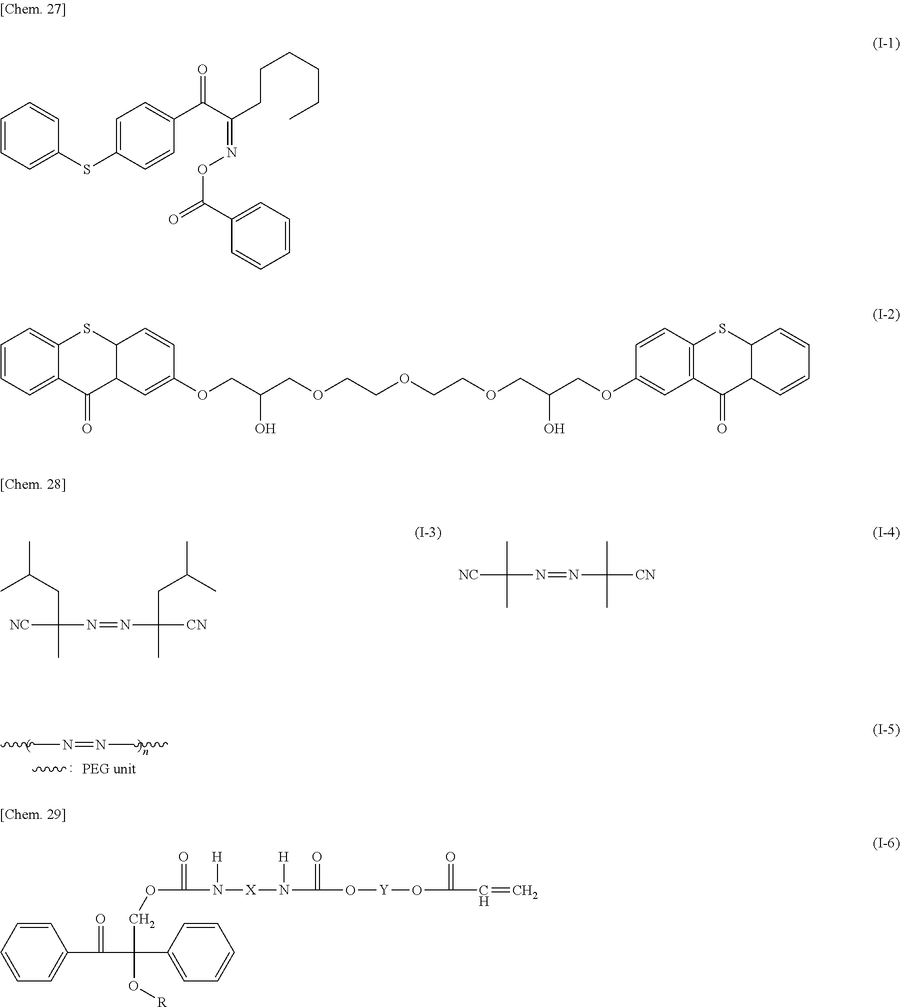

(where R denotes hydrogen or an aliphatic hydrocarbon residue having 4 or less carbon atoms, X denotes a residue of a bifunctional isocyanate derivative having 13 or less carbon atoms, and Y denotes an aliphatic hydrocarbon residue having 4 or less carbon atoms or a residue having a carbon to oxygen atomic ratio of 3 or less.)

The curable resin composition may further include a thermal curing agent. When heated, the thermal curing agent reacts with the thermally reactive functional groups in the curable resin composition to form crosslinks. The thermal curing agent serves to enhance the adhesion and moisture resistance of cured products of the curable resin composition.

The thermal curing agents are not particularly limited, and examples thereof include hydrazide compounds such as 1,3-bis[hydrazinocarbonoethyl-5-isopropylhydantoin] and adipic acid dihydrazide; dicyandiamide, guanidine derivatives, l-cyanoethyl-2-phenylimidazole, N-[2-(2-methyl-1-imidazolyl)ethyl]urea, 2,4-diamino-6-[2′-methylimidazolyl-(1′)]-ethyl-s-triazine, N,N′-bis(2-methyl-1-imidazolylethyl)urea, N,N′-(2-methyl-1-imidazolylethyl)-adipamide, 2-phenyl-4-methyl-5-hydroxymethylimidazole, 2-imidazoline-2-thiol, 2-2′-thiodiethanethiol, and addition products of various amines and epoxy resins. The thermal curing agents may be used singly, or two or more may be used in combination.

The curable resin composition, from which the seal portion 40 is formed, may contain a silane coupling agent. When the curable resin composition contains a silane coupling agent, the seal portion 40 may attain enhanced adhesion with respect to the substrates (the device substrate 10A and the counter substrate 20A).

The silane coupling agents are not particularly limited. Some suitable examples thereof are γ-aminopropyltrimethoxysilane, γ-mercaptopropyltrimethoxysilane, γ-glycidoxypropyltrimethoxysilane, γ-isocyanatopropyltrimethoxysilane, and imidazole silane compounds having a structure in which an imidazole backbone and an alkoxysilyl group are bonded together via a spacer group. The silane coupling agents may be used singly, or two or more may be used in combination.

The curable resin composition, from which the seal portion 40 is formed, may contain a filler for purposes such as to improve adhesion and improve linear expansion coefficient by stress dispersion effects, within limits not detrimental to the objects of the present invention.

The fillers that are used are not particularly limited. Examples thereof include inorganic fillers such as silica, diatomaceous earth, alumina, zinc oxide, iron oxide, magnesium oxide, tin oxide, titanium oxide, magnesium hydroxide, aluminum hydroxide, magnesium carbonate, barium sulfate, gypsum, calcium silicate, talc, glass beads, sericite activated clay, bentonite, aluminum nitride, and silicon nitride.

The curable resin composition, from which the seal portion 40 is formed, may further contain a gelling agent and a photosensitizer for photoreaction.

The liquid crystal display device 100A may include a columnar spacer that regulates the thickness of the liquid crystal layer 30.

Studies conducted by the present inventors have revealed that when the alignment layers include polyimide prepared from polyamic acid precursor and the liquid crystal layer includes a liquid crystal composition containing a radical scavenger as described above, the liquid crystal display device attains an improved VHR but encounters with another problem.

Specifically, a liquid crystal display device which has alignment layers including polyimide prepared by polymerization of polyamic acid and which has a liquid crystal composition containing a radical scavenger as described above can suffer an image quality deterioration which is caused by the radical scavenger contained in the liquid crystal composition.

The reactions which cause such image quality deteriorations are described below with reference to the formulae (I) and (II) below.

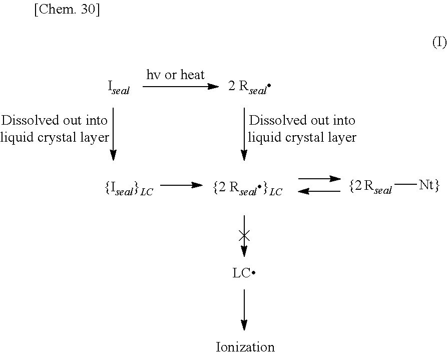

(where I: radical polymerization initiator, R.: radical generated from polymerization initiator, LC.: radical formed by reaction of liquid crystal molecule, and R-Nt: compound formed by reaction of radical with radical scavenger.)

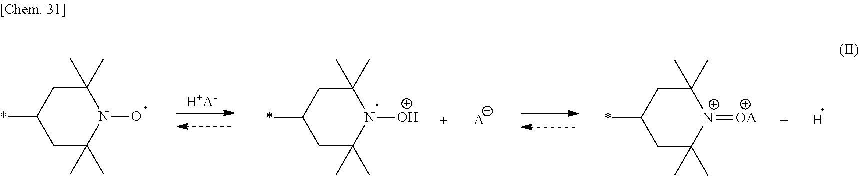

First, as shown in the formula (I), the radical polymerization initiator remaining in the seal portion, after being dissolved out into the liquid crystal layer or while staying in the seal portion, undergoes reaction to form radicals. The radicals of the radical polymerization initiator generated inside the seal portion are dissolved out into the liquid crystal layer.

If the liquid crystal layer contains no radical scavengers, there is a risk that the generated radicals react with the liquid crystal molecules to leave radicals of the liquid crystal molecules, which then react with surrounding substances to form ionic compounds. The resultant ionic compounds reduce the specific resistance of the liquid crystal composition, causing a decrease in VHR.

When, in contrast, the liquid crystal layer contains a radical scavenger, the radicals generated from the radical polymerization initiator react with the radical scavenger to form an electrically neutral compound. Thus, the liquid crystal composition does not lower its specific resistance, and the reduction in VHR can be suppressed.

In alignment layers formed from polyimide prepared from polyamic acid precursor, it is likely that the carboxylic acid derived from the polyamic acid remains on the surface of the alignment layers. In such a case, as shown in the formula (II), the radical scavenger contained in the liquid crystal composition may react with the carboxylic acid in the polyamic acid backbone to form an ionic impurity (a nitroso compound). Such impurities may decrease specific resistance of the liquid crystal composition and cause problems such as low VHR, image sticking, and spots on liquid crystal display devices. This reaction is accelerated in hot environments.

In light of such expected problems, the liquid crystal display device of the present invention has the imidization ratio of polyimide not less than 60% with respect to the whole polymer forming the alignment layers.

According to the above configuration, the high imidization ratio leads to a relative decrease in the amount of residual carboxyl groups in the polyamic acid backbone. Consequently, the reaction shown in the above formula (II) is less likely to occur, and the problems described above may be reduced or eliminated.

### (Imidization Ratio)

The imidization ratio of polyimide is not less than 60% of the whole polymer forming the alignment layers. This imidization ratio is preferably not less than 65%, more preferably not less than 70%, still more preferably not less than 75%, and even more preferably not less than 80%.

The imidization ratio of polyimide may be increased by:

(a) raising beforehand the imidization ratio of the polyamic acid to be used as the raw material for the polyimide, (b) extending the heating time (the reaction time) in the imidization reaction where the polyamic acid is heated and formed into polyimide, or

(c) elevating the heating temperature (the reaction temperature) in the imidization reaction where the polyamic acid is heated and formed into polyimide.

The imidization ratio of polyimide with respect to the whole material (the whole polymer) forming the first alignment layer 12 and the second alignment layer 22 is determined by analyzing the alignment layers by FT-IR. The FT-IR peak intensity assigned to amide groups is used to determine the peak intensity obtained by sufficiently heating the alignment layer at 350° C. to be completely imidized (the imidization ratio: 100%).

In the FT-IR spectrum of the alignment layer as produced, the peak that is observed near 1510 cm-1 and is identified to be derived from C—C bonds in an aromatic ring is used as the base for normalization. This peak assigned to such C—C bonds may not change its intensity or area even when the film is heat treated. On the other hand, the peak which corresponds to C—N stretching vibration of imide groups and is identified to be derived from imide rings is observed near 1370 cm⁻¹ and grows with the progress of heat treatment. Thus, calculations are made after the peak near 1370 cm⁻¹ is normalized with the peak near 1510 cm⁻¹.

The imidization ratio obtained after the alignment layer is sufficiently heated at 350° C. is taken as 100%, and the alignment layer with 100% imidization ratio is subjected to FT-IR measurement. In the FT-IR spectrum thus obtained, the peak near 1370 cm⁻¹ is normalized with the peak near 1510 cm⁻¹. The value thus obtained is designated as “A”.

The alignment layer of interest is similarly analyzed by FT-IR and the peak near 1370 cm⁻¹ in the spectrum is normalized with the peak near 1510 cm⁻¹. The value thus obtained is assigned as “B”.

Based on the values obtained above, the imidization ratio is determined from the following equation.

(Imidization ratio) (%)=B/A×100

The alignment layers are appropriately subjected to suitable alignment treatments to gain anchoring energy.

The liquid crystal display device of the present embodiment is configured as described hereinabove.

According to the liquid crystal display device having the above configuration, problems such as image sticking, spots, and a decrease in VHR can be prevented and can concurrently attain good image quality and low power consumption.

### Second Embodiment

FIG. 2 is a sectional view schematically illustrating a liquid crystal display device of the second embodiment of the present invention. The liquid crystal display device of the present embodiment is partly the same as the liquid crystal display device of the first embodiment. Thus, the constituent elements that are common to the first embodiment and the present embodiment are denoted by the same numerals, and detailed descriptions thereof are omitted.

As illustrated, the liquid crystal display device 100B of the present embodiment includes a device substrate 10B, a counter substrate 20B, a liquid crystal layer 30, and a seal portion 40. The device substrate 10B and the counter substrate 20B correspond to the “pair of substrates” in an aspect of the present invention.

### (Device Substrate)

The device substrate 10B includes a TFT substrate 11, a lower alignment layer 13 disposed on the surface of the TFT substrate 11 adjacent to the liquid crystal layer 30, an upper alignment layer 14 disposed on the surface of the lower alignment layer 13 in contact with the lower alignment layer 13, and a first polarizer 19 disposed on the surface of the TFT substrate 11 opposite to the liquid crystal layer 30.

Similarly to the first alignment layer 12 in the first embodiment, the lower alignment layer 13 is an alignment layer made of a polymer including polyimide. For example, the lower alignment layer 13 is a vertical alignment layer.

### (Counter Substrate)

For example, the counter substrate 20B includes a color filter substrate 21, a lower alignment layer 23 disposed on the surface of the color filter substrate 21 adjacent to the liquid crystal layer 30, an upper alignment layer 24 disposed on the surface of the lower alignment layer 23 in contact with the lower alignment layer 23, and a second polarizer 29 disposed on the surface of the color filter substrate 21 opposite to the liquid crystal layer 30.

Similarly to the second alignment layer 22 in the first embodiment, the lower alignment layer 23 is an alignment layer made of a polymer including polyimide. For example, the lower alignment layer 23 is a vertical alignment layer.

To address the problems discussed in the first embodiment which are expected when the liquid crystal layer includes a liquid crystal composition containing a radical scavenger, the liquid crystal display device of the present embodiment is configured so that the lower alignment layers 13, 23 including polyimide are covered with the upper alignment layers 14, 24 made of polysiloxane. The proportion of the polysiloxane is not less than 10 mass % and not more than 30 mass % of the entirety of the alignment layers.

According to the above configuration, the upper alignment layers including polysiloxane cover the carboxyl groups present on the surface of the lower alignment layers. Consequently, the radical polymerization initiator in the liquid crystal layer is not likely to react with the carboxyl groups, and the problems described above are less likely to occur.

The content of the polysiloxane in the alignment layers may be calculated by detecting Si—O skeletons by GC-MS.

### (Upper Alignment Layers)

The proportion of the polysiloxane is not less than 10 mass % and not more than 30 mass %, and preferably not less than 20 mass % and not more than 30 mass % of the entirety of the alignment layers.

The proportion of the polysiloxane in the entirety of the alignment layers may be controlled by adjusting the amount of polysiloxane to be mixed with the polyamic acid that is the raw material for the alignment layers.

The required amount of polysiloxane is suitably identified by fabricating a liquid crystal panel test cell that includes alignment layers composed of an upper alignment layer and a lower alignment layer, and testing the test cell for durability to examine the predetermined items such as image sticking, spots, and VHR changes. In this process, it is recommended that several test cells with different polysiloxane contents be provided and tested for durability to determine the required amount of polysiloxane.

Examples of the polysiloxanes which may be used include those which have a siloxane skeleton represented by the formula (20) below or a siloxane skeleton represented by the formula (21) below and have any of the formulae (Z-11) below to (Z-18) as the side chain unit Z.

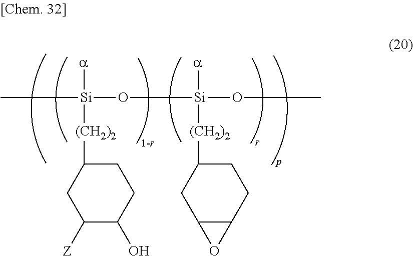

(where α denotes a hydrogen atom, a hydroxyl group, or an alkoxy group, and the plurality of α may be the same as or different from one another.

r is 0≤r≤0.8, and p denotes an integer.)

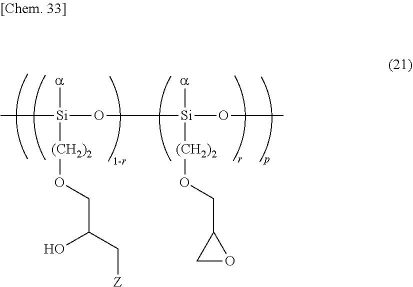

(where α denotes a hydrogen atom, a hydroxyl group, or an alkoxy group, and the plurality of α may be the same as or different from one another.

r is 0≤r≤0.8, and p denotes an integer.)

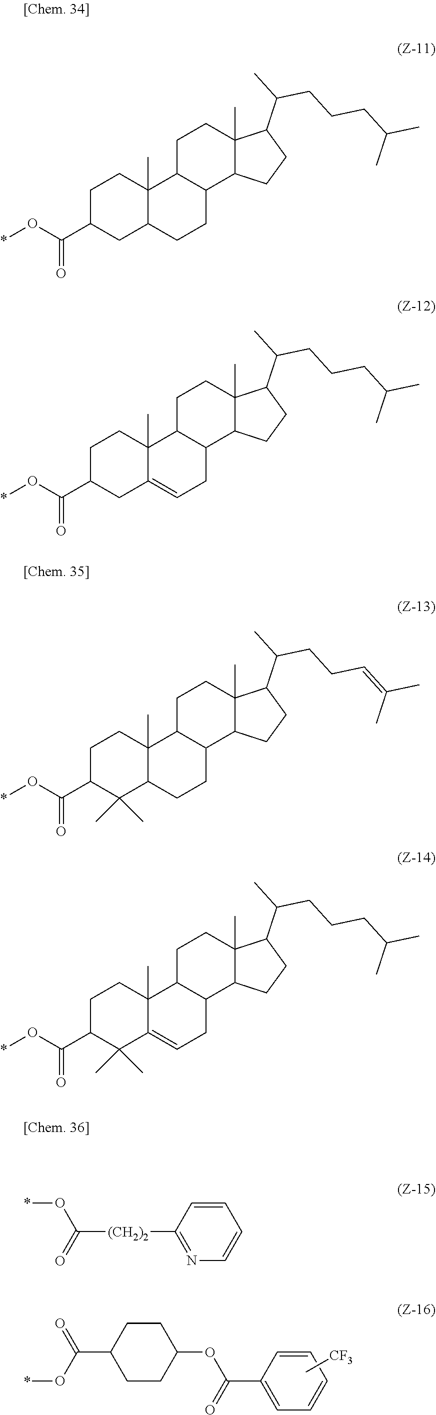

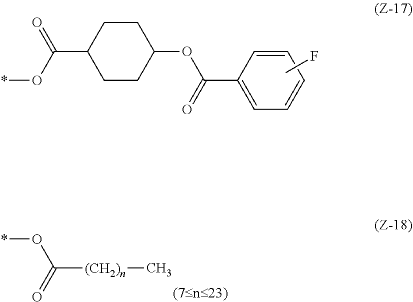

The alignment layers of the present embodiment in which the upper alignment layer and the lower alignment layer are layered may be produced as follows.

First, a mixture solution including the raw material polyamic acid and polysiloxane is applied onto the substrate.

The solution may be applied by any of various known methods as long as a film with a desired thickness can be obtained. For example, among those, spin coating methods, bar coating methods, inkjetting methods, slit coating methods, and screen printing methods may be adopted.

Next, the solvent is removed from the mixture solution that has been applied, and the resultant film is further pre-baked to dryness. In the manner described above, a multilayer is formed which is composed of a layer of the polyamic acid and a layer of the polysiloxane.

When the solvent is removed, the drying may be accelerated by removing the solvent by standing, heating, reducing the pressure, air blowing, or a combination thereof.

Since the polysiloxane is more hydrophobic than the polyamic acid, the mixture is separated into layers during the baking so that the polysiloxane becomes interfaced with air.

Next, the multilayer is heated. By this heating, the polyamic acid and the polysiloxane are caused to polymerize separately, lose fluidity, and are cured.

In the alignment layers formed as described above, it is preferable that the lower alignment layers (the polyimide layers) located on the substrate side have an increased imidization ratio for the same reasons as described in the first embodiment.

In this embodiment, the imidization ratio of polyimide is preferably not less than 45% with respect to the whole polymer forming the lower alignment layers 13, 23. The imidization ratio of polyimide is more preferably not less than 50%, still more preferably not less than 60%, and even more preferably not less than 65% with respect to the whole polymer forming the lower alignment layers 13, 23. The imidization ratio of polyimide is furthermore preferably not less than 70%, more preferably not less than 75%, and even more preferably not less than 80% with respect to the whole polymer forming the lower alignment layers 13, 23.

According to the above configuration, an increase in the imidization ratio leads to a relative decrease in the amount of residual carboxyl groups in the polyamic acid backbone. Consequently, even if the radical scavenger reaches the lower alignment layer over the upper alignment layer, the reaction shown in the above formula (II) is less likely to occur, and the liquid crystal display device may not suffer the problems described above.

In the manner described above, the alignment layers included in the liquid crystal display device 100B of the present embodiment can be produced.

The liquid crystal display device of the present embodiment is configured as described hereinabove.

The liquid crystal display device having the above configuration can be prevented from problems such as image sticking, spots, and a decrease in VHR, and can concurrently attain good image quality and low power consumption.

In the liquid crystal display device of the present embodiment, preferably the imidization ratio in the alignment layers is not less than 60%.

### Third Embodiment

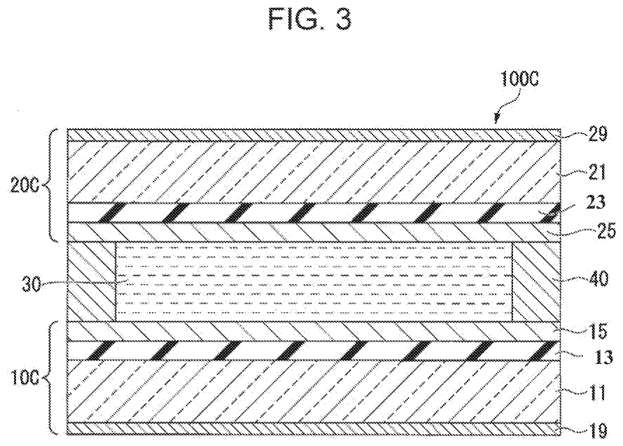

FIG. 3 is a sectional view schematically illustrating a liquid crystal display device of the third embodiment of the present invention. As illustrated, the liquid crystal display device 100C of the present embodiment includes a device substrate 10C, a counter substrate 20C, a liquid crystal layer 30, and a seal portion 40. The device substrate 10C and the counter substrate 20C correspond to the “pair of substrates” in an aspect of the present invention.

### (Device Substrate)

The device substrate 10C includes a TFT substrate 11, a lower alignment layer 13 disposed on the surface of the TFT substrate 11 adjacent to the liquid crystal layer 30, a surface treatment layer 15 disposed on the surface of the lower alignment layer 13 in contact with the lower alignment layer 13, and a first polarizer 19 disposed on the surface of the TFT substrate 11 opposite to the liquid crystal layer 30.

### (Counter Substrate)

For example, the counter substrate 20C includes a color filter substrate 21, a lower alignment layer 23 disposed on the surface of the color filter substrate 21 adjacent to the liquid crystal layer 30, a surface treatment layer 25 disposed on the surface of the lower alignment layer 23 in contact with the lower alignment layer 23, and a second polarizer 29 disposed on the surface of the color filter substrate 21 opposite to the liquid crystal layer 30.

To address the problems discussed in the first embodiment which are expected when the liquid crystal layer includes a liquid crystal composition containing a radical scavenger, the liquid crystal display device of the present embodiment is configured so that the lower alignment layers 13, 23 including polyimide are covered with the surface treatment layers 15, 25.

According to the above configuration, the silane coupling agent reacts with the polyimide and consumes the carboxyl groups in the polyamic acid backbone. Because less carboxyl groups remain in the polyamic acid backbone, the radical polymerization initiator in the liquid crystal layer is less likely to react with the carboxyl groups, and the problems described above may be reduced or eliminated.

The consumption of carboxyl groups by the reaction with the silane coupling agent may be confirmed by tracking the conversion of carboxyl groups into —COO— groups by FT-IR.

### (Silane Coupling Agent)

The silane coupling agent has a functional group capable of forming a covalent bond with the carboxyl group in the polyamic acid backbone. The thickness of a surface modification layer may be controlled by adjusting the amount of use of the silane coupling agent described later.

The required amount of the silane coupling agent is suitably identified by fabricating a liquid crystal panel test cell including an alignment layer whose surface has been modified with the silane coupling agent, and testing the test cell for durability to examine the predetermined items such as image sticking, spots, and VHR changes. In this process, it is recommended that several test cells with different amounts of surface modification be prepared and tested for durability to determine the required amount of surface modification.

Examples of the silane coupling agents which may be used include compounds represented by the formula (D) below.

[Chem. 37]

R₃Si—Z (D)

(where R denotes a chlorine atom or a C₁₋₄ alkoxy group, and Z denotes a substituent represented by any of the formulae (D1) to (D19) below.)

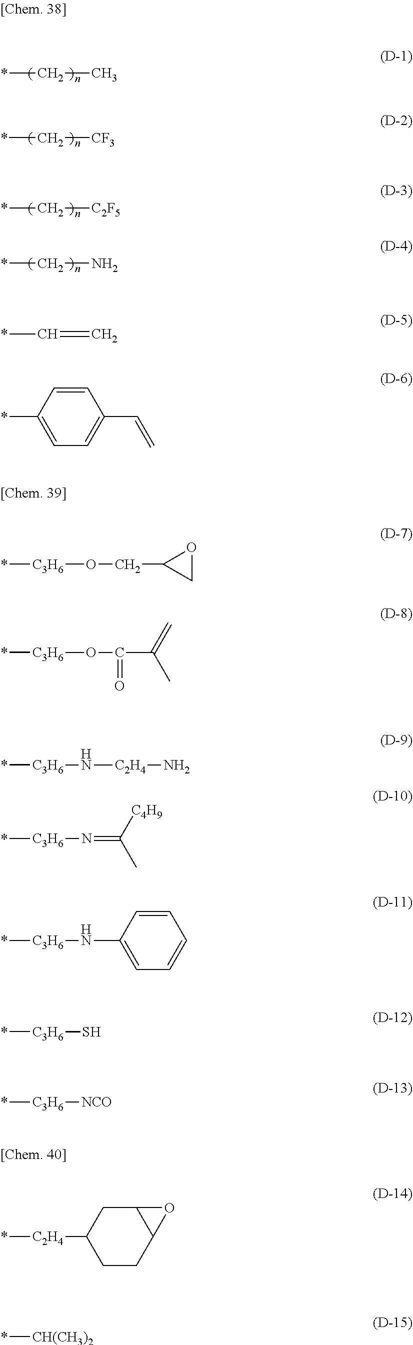

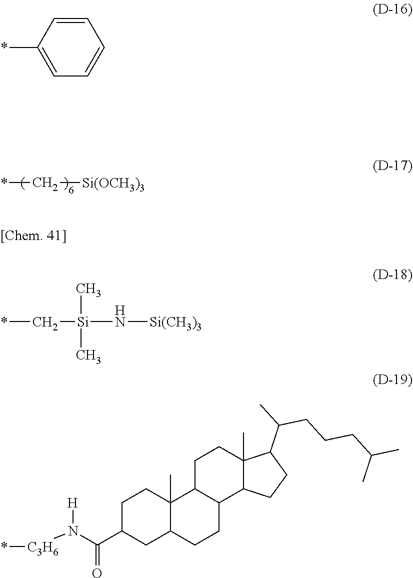

(where n denotes an integer of 1 to 18.)

The above silane coupling agent is suitably used when the alignment layers are vertical alignment layers. It is needless to mention that the silane coupling agent may have other side chains and be used for horizontal alignment layers.

In the alignment layers formed as described above, it is preferable that the lower alignment layers (the polyimide layers) located on the substrate side have an increased imidization ratio for the same reasons as described in the first embodiment.

In this embodiment, the imidization ratio of polyimide is preferably not less than 45% with respect to the whole polymer forming the lower alignment layers 13, 23. The imidization ratio of polyimide is more preferably not less than 50%, still more preferably not less than 60%, and even more preferably not less than 65% with respect to the whole polymer forming the lower alignment layers 13, 23. The imidization ratio of polyimide is furthermore preferably not less than 70%, more preferably not less than 75%, and even more preferably not less than 80% with respect to the whole polymer forming the lower alignment layers 13, 23.

According to the above configuration, an increase in the imidization ratio leads to a relative decrease in the amount of residual carboxyl groups in the polyamic acid backbone. Consequently, even if the radical scavenger reaches the lower alignment layer over the surface treatment layer, the reaction shown in the above formula (II) is less likely to occur, and the liquid crystal display device may not suffer the problems described above.

The liquid crystal display device of the present embodiment is configured as described hereinabove.

According to the liquid crystal display device having the above configuration, problems such as image sticking, spots, and a decrease in VHR can be prevented, and concurrently good image quality and low power consumption can be attained.

In the liquid crystal display device of the present embodiment, preferably the imidization ratio in the alignment layers is not less than 60%.

### Fourth Embodiment

### <Electronic Device>

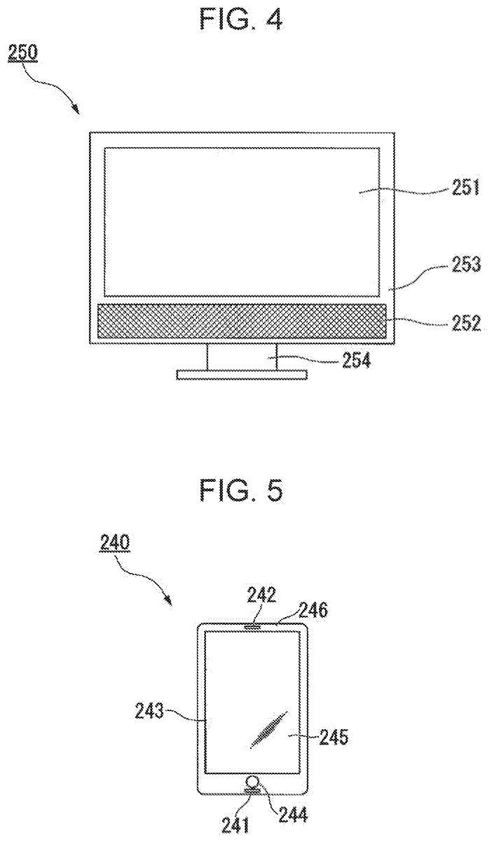

FIGS. 4 to 7 are schematic views illustrating electronic devices of the present embodiment. The electronic devices of the present embodiment each include the liquid crystal panel described above and a controller that supplies driving signals to the liquid crystal panel.

The flat-screen TV 250 illustrated in FIG. 4 includes a display section 251, a speaker 252, a cabinet 253, and a stand 254. The liquid crystal display device described hereinabove may be suitably used as the display section 251. The flat-screen TV can thus concurrently attain good image quality and low power consumption.

The smartphone 240 illustrated in FIG. 5 includes a voice input section 241, a voice output section 242, an operating switch 244, a display section 245, a touch panel 243, and a chassis 246. The liquid crystal display device described hereinabove may be suitably used as the display section 245. The smartphone can thus concurrently attain good image quality and low power consumption.

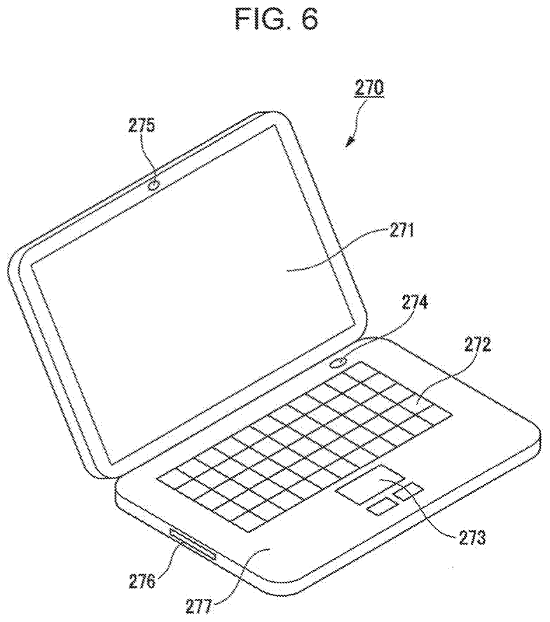

The laptop computer 270 illustrated in FIG. 6 includes a display section 271, a keyboard 272, a touch pad 273, a main switch 274, a camera 275, a recording medium slot 276, and a chassis 277.

The liquid crystal display device described hereinabove may be suitably used as the display section 271. The laptop computer can thus concurrently attain good image quality and low power consumption.

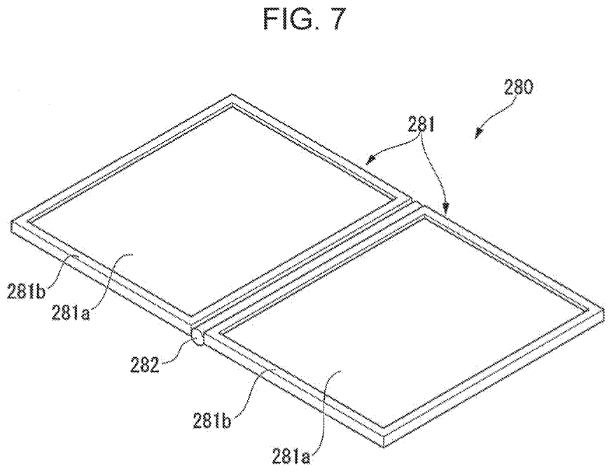

The mobile electronic device 280 illustrated in FIG. 7 includes two display sections 281 and a hinge mechanism 282 that connects the two display sections 281 together. The hinge mechanism 282 enables the display sections 281 to be folded. The display section 281 includes a display panel 281a and a chassis 281b. The liquid crystal panels described hereinabove may be suitably used as the display panels 281a. The mobile electronic device can thus concurrently attain good image quality and low power consumption. Further, the low power consumption characteristics make it possible to reduce the battery capacity as compared to existing mobile electronic devices, and thus realize weight reduction.

A curved lens may be arranged on the display sections 281 to display a seamless image on the two display sections 281.

The liquid crystal display devices described hereinabove are resistant to deteriorations even when exposed to high-temperature environments, and thus can be suitably used as display sections in devices that may be used in hot environments such as outdoors or in vehicles in summer, for example, portable electronic devices and car-mounted displays.

The electronic devices of the present embodiment can concurrently attain good image quality and low power consumption by virtue of having the above-described liquid crystal display devices as display sections.

While some preferred embodiments of an aspect of the present invention have been illustrated with reference to the appended drawings, it is needless to mention that the aspect of the present invention is not limited to such embodiments. The configuration discussed above such as the shapes and combinations of constituent members may be only illustrative, and various modifications based on requirements such as designs are possible without departing from the spirit of the present invention.

### Examples

The present invention is described based on Examples hereinbelow. The scope of an aspect of the present invention is, however, not limited to such Examples.

Liquid crystal cells fabricated as described later were analyzed by the following methods to evaluate properties.

### (Imidization Ratio)

The imidization ratio was determined by analyzing the alignment layers by FT-IR. The FT-IR peak intensity assigned to amide groups was used to determine the peak intensity obtained by sufficiently heating the alignment layer at 350° C. to be completely imidized (the imidization ratio: 100%).

In the FT-IR spectrum of the alignment layer, the peak that was observed near 1510 cm⁻¹ and was identified to be derived from C—C bonds was used as the base for normalization. This peak assigned to C—C bonds may not change its intensity or area even when the film is heat treated. On the other hand, the peak which is identified to be derived from imide rings is observed near 1370 cm⁻¹ and grows with the progress of heat treatment. Thus, calculations were made after the peak near 1370 cm⁻¹ was normalized with the peak near 1510 cm⁻¹.

The imidization ratio obtained after the alignment layer was sufficiently heated at 350° C. was taken as 100%, and the alignment layer with 100% imidization ratio was subjected to FT-IR measurement. In the FT-IR spectrum thus obtained, the peak near 1370 cm⁻¹ was normalized with the peak near 1510 cm⁻¹. The value thus obtained was designated as “A”.

The alignment layer of interest was similarly analyzed by FT-IR and the peak near 1370 cm⁻¹ in the spectrum was normalized with the peak near 1510 cm⁻¹. The value thus obtained was assigned as “B”.

Based on the values obtained above, the imidization ratio was determined from the following equation.

(Imidization ratio) (%)=B/A×100

### (VHR (Voltage Holding Ratio))

The VHR was measured at 1 V and 70° C. with VHR measurement system 6254 manufactured by TOYO Corporation. Here, the VHR means the proportion of charges held after one frame period.

The higher the VHR, the higher the quality of the liquid crystal display device. The liquid crystal display device is more durable and of higher quality with smaller decrease in VHR after durability testing.

### (Residual DC)

The residual DC was measured by a flicker elimination method. The residual DC (rDC) was measured after a DC offset voltage of 2 V (AC voltage 3 V (60 Hz)) was applied for 2 hours in an oven at 40° C.

The smaller the rDC, the higher the quality of the liquid crystal display device. The liquid crystal display device is more durable and of higher quality with smaller increase in rDC after durability testing.

In EXAMPLES and COMPARATIVE EXAMPLES described below, the advantageous effects of the present invention were examined based on the amounts of changes in VHR and residual DC after the durability test under the conditions described later. The values of VHR and residual DC were compared to one another in each of <EVALUATION 1> to <EVALUATION 4> independently of one another, in other words, the superiority or inferiority of the properties was not evaluated by comparing the magnitudes of values between the evaluations performed under different preconditions.

### <Evaluation 1>

### Example 1-1

A device substrate having pixel electrodes and a counter substrate having a common electrode were prepared. A solution of polyamic acid of the formula (100) below was applied onto the surface of both substrates, and the coatings were dried. The solvent that was used was a 1:1 (by mass) mixture of N-methylpyrrolidone (NMP) and γ-butyrolactone.

The polyamic acid in the solvent had 0% imidization ratio.

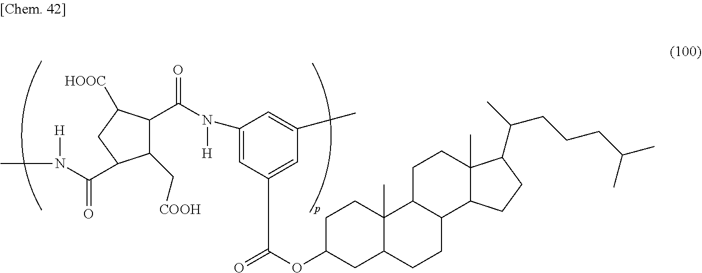

Next, the coatings were pre-baked at 80° C. and were post-baked at 200° C. for 60 minutes. Thus, alignment layers were formed on the respective surfaces of the device substrate and the counter substrate.

Next, a sealing raw material (a sealant) was applied to draw a seal portion on the alignment layer-coated side of the device substrate. In this process, the sealant drew a closed ring as seen from above.

The sealant was a photocurable resin which contained a mixture of epoxy resin and acrylic resin, and a radical polymerization initiator (IRGACURE OXE01) represented by the formula (101) below. The radical polymerization initiator represented 2 mass % of the sealant.

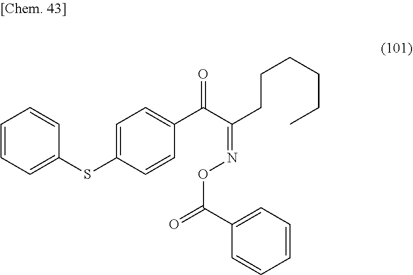 [SMILES: CCCCCC/C(=N/OC(=O)c1ccccc1)C(=O)c1ccc(Sc2ccccc2)cc1]

After the sealant had been applied, a negative (having a negative dielectric anisotropy) liquid crystal composition which contained 500 ppm radical scavenger represented by the formula (102) below was dropped onto the region of the device substrate enclosed by the sealant. The liquid crystal composition used had a range of nematic liquid crystal phase temperatures of −30 to 90° C.

The liquid crystal composition further contained an alkoxy-containing liquid crystal compound represented by the formula (103) below, and an alkenyl-containing liquid crystal compound represented by the formula (104) below.

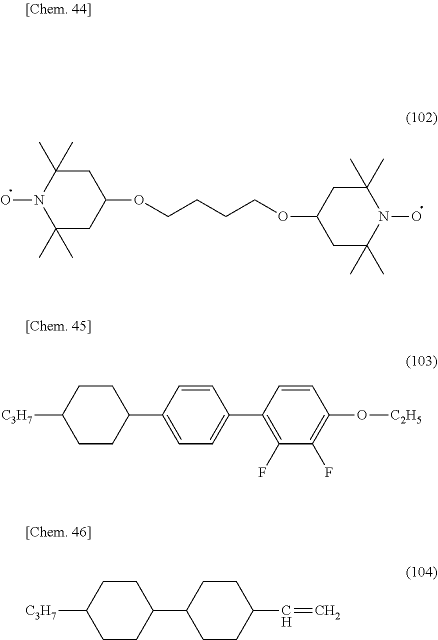

Next, the sealant was pre-cured by UV irradiation. The light source used in the UV irradiation was capable of emitting UV light with wavelengths of 300 to 400 nm and had an illuminance near 365 nm of 15 mW/cm². The amount of UV application time was 3 minutes. The alignment layer-coated side of the counter substrate was opposed to the liquid crystal composition, and the device substrate and the counter substrate were bonded together. The resultant was then heated at 130° C., which was not less than the nematic phase transition temperature (Tni) of the liquid crystal composition, for 20 minutes to thermally cure the sealant and to align the liquid crystal composition. Thus, a liquid crystal cell (a liquid crystal display device) of EXAMPLE 1-1 was obtained.

### Examples 1-2 to 1-4

Liquid crystal cells of EXAMPLES 1-2 to 1-4 were obtained in the same manner as in EXAMPLE 1-1, except that the imidization ratio of the raw material for alignment layers in the solvent was changed to 20%, 40%, or 60%.

### COMPARATIVE EXAMPLES 1-1 to 1-4

Liquid crystal cells of COMPARATIVE EXAMPLES 1-1 to 1-4 were obtained in the same manner as in EXAMPLES 1-1 to 1-4, except that the radical scavenger of the above formula (102) was not added to the liquid crystal composition.

### Comparative Example 1-5

A liquid crystal cell of COMPARATIVE EXAMPLE 1-5 was obtained in the same manner as in EXAMPLE 1-1, except that the post-baking in the fabrication of alignment layers was performed at 200° C. for 40 minutes.

### Reference Example

A liquid crystal cell of REFERENCE EXAMPLE was fabricated by a vacuum injection method using the same materials as those in EXAMPLE 1-1, except that the liquid crystal composition did not contain the radical scavenger of the above formula (102), and the sealant did not contain the radical polymerization initiator of the formula (101) below.

### (Durability Test)

The liquid crystal cells were each exposed to light from a backlight source in an oven at 80° C. for 500 hours. The durability was evaluated by measuring the VHR and the residual DC before and after the durability test.

Table 1 describes the results of <EVALUATION 1>.

TABLE 1

| | | | Before | | After | |
|---|---|---|---|---|---|---|
| | Imidization | Radical | durability test | | durability test | |
| | ratio (%) | scavenger | VHR (%) | rDC (V) | VHR (%) | rDC (V) |
| EX. 1-1 | 60 | Present | 98.5 | 0.04 | 94.0 | 0.18 |
| EX. 1-2 | 68 | Present | 98.5 | 0.04 | 97.0 | 0.08 |
| EX. 1-3 | 76 | Present | 99.0 | 0.05 | 97.5 | 0.07 |
| EX. 1-4 | 84 | Present | 99.0 | 0.05 | 97.7 | 0.07 |
| COMP. EX. 1-1 | 60 | Absent | 99.5 | 0.03 | 90.5 | 0.43 |
| COMP. EX. 1-2 | 68 | Absent | 99.5 | 0.03 | 90.5 | 0.43 |
| COMP. EX. 1-3 | 76 | Absent | 99.5 | 0.03 | 91.0 | 0.44 |
| COMP. EX. 1-4 | 84 | Absent | 99.5 | 0.03 | 91.0 | 0.48 |
| COMP. EX. 1-5 | 50 | Present | 98.8 | 0.04 | 91.5 | 0.42 |
| REF. EX. | 60 | Absent | 99.5 | 0.03 | 98.0 | 0.08 |

From the comparison among EXAMPLES 1-1 to 1-4, it has been shown that a decrease in VHR after the durability test was suppressed in the liquid crystal cells with increasing imidization ratio of the alignment layers. It has been also shown that an increase in residual DC was suppressed in the liquid crystal cells with increasing imidization ratio of the alignment layers.

In contrast, VHR and residual DC after the durability test deteriorated in the liquid crystal cells of COMPARATIVE EXAMPLES 1-1 to 1-5 in which the liquid crystal composition did not contain the radical scavenger.

The liquid crystal cell of REFERENCE EXAMPLE in which the liquid crystal composition did not contain the radical scavenger and the sealant was free from the polymerization initiator was evaluated. Deteriorations in VHR and residual DC after the durability test were suppressed in the liquid crystal cell of REFERENCE EXAMPLE. However, since the liquid crystal cell of REFERENCE EXAMPLE was fabricated by the vacuum injection method, productivity was less than that of the liquid crystal cells of EXAMPLES 1-1 to 1-4 which were produced by the ODF method.

### <Evaluation 2>

### Example 2-1

The liquid crystal cell of EXAMPLE 1-1 was used as a liquid crystal cell of EXAMPLE 2-1.

### Examples 2-2 to 2-4

Liquid crystal cells of EXAMPLES 2-2 to 2-4 were obtained in the same manner as in EXAMPLE 2-1, except that the polyamic acid applied to the surface of the substrates was post-baked at 220° C., 230° C., or 250° C.

### Example 2-5

A liquid crystal cell of EXAMPLE 2-5 was obtained in the same manner as in EXAMPLE 2-4, except that the liquid crystal composition contained 1500 ppm of the radical scavenger of the above formula (102).

### Reference Examples 2-1 to 2-4

Liquid crystal cells of REFERENCE EXAMPLES 2-1 to 2-4 were obtained in the same manner as in EXAMPLES 2-1 to 2-4, except that the liquid crystal composition was replaced by one which had a range of nematic liquid crystal phase temperatures of −30 to 75° C.

Table 2 describes the results of <EVALUATION 2>.

TABLE 2

| | | | Before | | | |
|---|---|---|---|---|---|---|
| | Imidization | Radical | durability test | | After durability test | |
| | ratio (%) | scavenger | VHR (%) | rDC (V) | VHR (%) | rDC (V) |
| EX. 2-1 | 60 | Present | 98.5 | 0.04 | 94.0 | 0.18 |
| EX. 2-2 | 68 | Present | 98.5 | 0.04 | 97.0 | 0.08 |
| EX. 2-3 | 73 | Present | 99.0 | 0.04 | 97.2 | 0.07 |
| EX. 2-4 | 82 | Present | 99.0 | 0.05 | 97.6 | 0.07 |
| EX. 2-5 | 82 | Present | 99.0 | 0.05 | 96.2 | 0.13 |
| REF. EX. 2-1 | 60 | Present | 98.4 | 0.05 | 93.4 | 0.21 |
| | | | | | | (misaligned) |
| REF. EX. 2-2 | 68 | Present | 98.6 | 0.05 | 95.2 | 0.16 |
| | | | | | | (misaligned) |
| REF. EX. 2-3 | 73 | Present | 98.7 | 0.04 | 96.4 | 0.15 |
| | | | | | | (misaligned) |
| REF. EX. 2-4 | 82 | Present | 98.6 | 0.05 | 97.0 | 0.12 |
| | | | | | | (misaligned) |

The evaluations have shown that the liquid crystal cells of EXAMPLES 2-1 to 2-4 were more durable than the liquid crystal cells of REFERENCE EXAMPLES 2-1 to 2-4.

The comparison between EXAMPLE 2-4 and EXAMPLE 2-5 has shown that it is preferable to add 1000 ppm or less radical scavenger.

In the liquid crystal cells of REFERENCE EXAMPLES 2-1 to 2-4, it is probable that the liquid crystal composition in the liquid crystal layer had become isotropic during the durability test and was less likely to be influenced with the alignment layers. Such a state that “the alignment layers are less influential on the liquid crystal composition” may be a state of “relatively more susceptible to adverse impacts by the radical polymerization initiator dissolved out from the sealant”. Probably because of this, the alignment layers in the liquid crystal cells of REFERENCE EXAMPLES 2-1 to 2-4 deteriorated more than those in the liquid crystal cells of EXAMPLES 2-1 to 2-4, thus causing misalignment.

### <Evaluation 3>

### Example 3-1

A device substrate having pixel electrodes (with slits), and a counter substrate having ribs and a common electrode were prepared. A solution which included polyamic acid of the above formula (100) and polysiloxane of the formula (105) below was applied onto the surface of both substrates, and the coatings were dried. The solvent that was used was a 1:1 (by mass) mixture of N-methylpyrrolidone (NMP) and γ-butyrolactone. The polyamic acid in the solvent had 0% imidization ratio. The mass ratio of the polyamic acid to the polysiloxane was [Polyamic acid]:[Polysiloxane]=90:10. That is, the content of the polysiloxane was 10 mass % of the raw material for alignment layers.

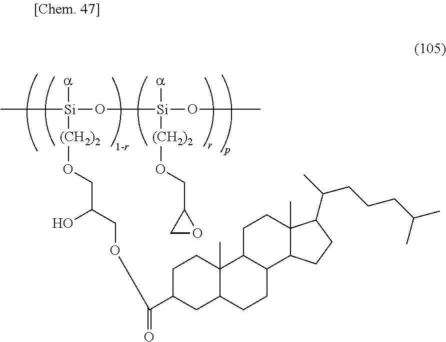

Next, the coatings were pre-baked at 80° C. and were post-baked at 200° C. for 40 minutes. Consequently, a multilayer was formed in which the polyamic acid of the above formula (100) to be a polyimide layer was provided on the substrate, and the polysiloxane of the above formula (105) to be a polysiloxane layer was provided on top of the polyimide layer.

Next, a sealing raw material (a sealant) was applied to draw a seal portion on the alignment layer-coated side of the device substrate. In this process, the sealant drew a closed ring as seen from above.

The sealant was a photocurable resin which contained a mixture of epoxy resin and acrylic resin, a photo radical polymerization initiator represented by the formula (106) below, and a thermal radical polymerization initiator represented by the formula (107) below. The photo radical polymerization initiator represented 2.0 mass % of the sealant. The thermal radical polymerization initiator represented 1.5 mass % of the sealant. That is, the content of the radical polymerization initiators was 3.5 mass % of the sealant.

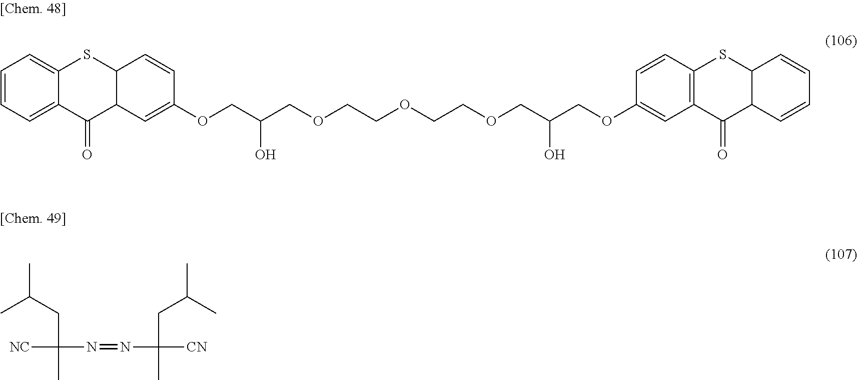 [SMILES: O=C1c2ccccc2SC2C=CC(OCC(O)COCCOCCOCC(O)COc3ccc4c(c3)C(=O)C3C=CC=CC3S4)=CC12 ; CC(C)CC(C)(C#N)N=NC(C)(C#N)CC(C)C]

After the sealant had been applied, a negative (having a negative dielectric anisotropy) liquid crystal composition which contained 800 ppm radical scavenger represented by the formula (108) below was dropped onto the region of the device substrate enclosed by the sealant. The liquid crystal composition used had a range of nematic liquid crystal phase temperatures of −30 to 92° C. The liquid crystal composition further contained an alkoxy-containing liquid crystal compound represented by the above formula (103), and an alkenyl-containing liquid crystal compound represented by the above formula (104).

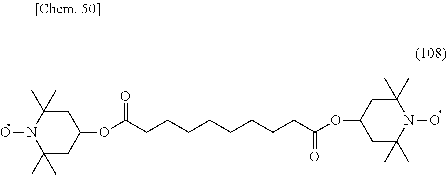

Next, the sealant was pre-cured by UV irradiation. The light source used in the UV irradiation was capable of emitting UV light with wavelengths of 300 to 400 nm and had an illuminance near 365 nm of 15 mW/cm². The amount of UV application time was 3 minutes. The alignment layer-coated side of the counter substrate was opposed to the liquid crystal composition, and the device substrate and the counter substrate were bonded together. The resultant was then heated at 130° C., which was not less than the nematic phase transition temperature (Tni) of the liquid crystal composition, for 40 minutes to thermally cure the sealant and to align the liquid crystal composition. Thus, a liquid crystal cell (a liquid crystal display device) of EXAMPLE 3-1 was obtained.

### Example 3-2

A liquid crystal cell of EXAMPLE 3-2 was obtained in the same manner as in EXAMPLE 3-1, except that the raw material for alignment layers was changed to a mixture of polyamic acid and polysiloxane with a mass ratio [Polyamic acid]:[Polysiloxane] of 80:20, that is, the content of the polysiloxane was 20 mass % of the raw material for alignment layers.

### Example 3-3

A liquid crystal cell of EXAMPLE 3-3 was obtained in the same manner as in EXAMPLE 3-1, except that the raw material for alignment layers was changed to a mixture of polyamic acid and polysiloxane with a mass ratio [Polyamic acid]:[Polysiloxane] of 70:30, that is, the content of the polysiloxane was 30 mass % of the raw material for alignment layers.

### Comparative Examples 3-1 to 3-3

Liquid crystal cells of COMPARATIVE EXAMPLES 3-1 to 3-3 were obtained in the same manner as in EXAMPLES 3-1 to 3-3, except that the liquid crystal composition did not contain the radical scavenger of the above formula (108).

### Comparative Example 3-4

A liquid crystal cell of COMPARATIVE EXAMPLE 3-4 was obtained in the same manner as in EXAMPLE 3-1, except that the raw material for alignment layers was changed to a mixture having a mass ratio of polyamic acid to polysiloxane of [Polyamic acid]:[Polysiloxane]=100:0, that is, the content of polysiloxane was 0 mass % of the raw material for alignment layers.

Table 3 describes the results of <EVALUATION 3>.

TABLE 3

| | Polysiloxane | | | Before | | | |
|---|---|---|---|---|---|---|---|
| | content | Imidization | Radical | durability test | | After durability test | |
| | (mass %) | ratio (%) | scavenger | VHR (%) | rDC (V) | VHR (%) | rDC (V) |
| EX. 3-1 | 10 | 45 | Present | 98.4 | 0.05 | 97.1 | 0.07 |
| EX. 3-2 | 20 | 45 | Present | 98.4 | 0.05 | 97.7 | 0.06 |
| EX. 3-3 | 30 | 45 | Present | 98.8 | 0.05 | 98.0 | 0.06 |
| COMP. EX. 3-1 | 10 | 45 | Absent | 99.1 | 0.01 | 88.7 | 0.15 |
| COMP. EX. 3-2 | 20 | 45 | Absent | 99.3 | 0.01 | 90.3 | 0.13 |
| COMP. EX. 3-3 | 30 | 45 | Absent | 99.3 | 0.00 | 90.3 | 0.12 |
| COMP. EX. 3-4 | 0 | 45 | Present | 98.4 | 0.05 | 94.5 | 0.16 |

The evaluations have shown that the liquid crystal cells of EXAMPLES 3-1 to 3-3 were more durable than the liquid crystal cells of COMPARATIVE EXAMPLES 3-1 to 3-4. This is probably because the liquid crystal cells of EXAMPLES 3-1 to 3-3 had the polysiloxane layer between the liquid crystal layer and the polyimide layer, which suppressed the reaction of the residual carboxyl groups in the polyimide layer with the radical scavenger contained in the liquid crystal layer.

### <Evaluation 4>

### Example 4-1

Alignment layers were formed on the surface of a device substrate and a counter substrate in the same manner as in EXAMPLE 1-1.

Next, the substrates were soaked into a 3 mass % ethanol solution of a silane coupling agent represented by the formula (109) below, and were heated at 60° C. for 60 minutes. The substrates were then removed from the ethanol solution and were cleaned of ethanol by being heated in an oven at 150° C. for 60 minutes.

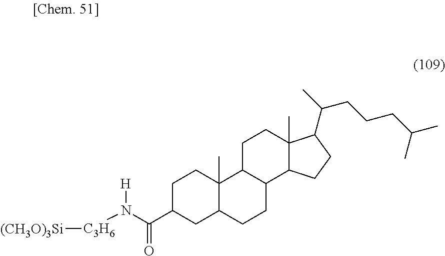

The rest of the procedures was performed in the same manner as in EXAMPLE 3-1. A liquid crystal cell of EXAMPLE 4-1 was thus obtained.

### Comparative Example 4-1

A liquid crystal cell of COMPARATIVE EXAMPLE 4-1 was obtained in the same manner as in EXAMPLE 4-1, except that the liquid crystal composition did not contain the radical scavenger of the above formula (108).

### Comparative Example 4-2

The liquid crystal cell of COMPARATIVE EXAMPLE 3-4 was used as a liquid crystal cell of COMPARATIVE EXAMPLE 4-2.

Table 4 describes the results of <EVALUATION 4>.

TABLE 4

| | | | | Before | | | |
|---|---|---|---|---|---|---|---|
| | Surface | Imidization | Radical | durability test | | After durability test | |
| | treatment | ratio (%) | scavenger | VHR (%) | rDC (V) | VHR (%) | rDC (V) |
| EX. 4-1 | Yes | 45 | Present | 98.7 | 0.05 | 98.2 | 0.06 |
| COMP. EX. 4-1 | Yes | 45 | Absent | 98.9 | 0.01 | 91.0 | 0.19 |
| COMP. EX. 4-2 | No | 45 | Present | 98.4 | 0.05 | 94.5 | 0.16 |

The evaluations have shown that the liquid crystal cell of EXAMPLE 4-1 was more durable than the liquid crystal cells of COMPARATIVE EXAMPLES 4-1 and 4-2.

In the liquid crystal cell of EXAMPLE 4-1, it is probable that the silane coupling agent was bonded to the surface of the polyimide layer in such a manner that the residual carboxyl groups present on the surface of the polyimide layer were consumed and reduced in number by the reaction with the alkoxy groups in the silane coupling agent. Consequently, reaction between the radical scavenger contained in the liquid crystal layer probably and the residual carboxyl groups on the polyimide layer was suppressed, and the liquid crystal cell of EXAMPLE 4-1 attained enhanced durability.

Another reason is probably because, in the liquid crystal cell of EXAMPLE 4-1, the silane coupling agent layer was formed between the liquid crystal layer and the polyimide layer, which suppressed the reaction between the residual carboxyl groups in the polyimide layer and the radical scavenger contained in the liquid crystal layer.

From the foregoing results, the usefulness of an aspect of the present invention has been demonstrated.

### INDUSTRIAL APPLICABILITY

Some aspects of the present invention may be applied to devices such as liquid crystal display devices and electronic devices to concurrently attain good image quality and low power consumption.

### REFERENCE SIGNS LIST

10 DEVICE SUBSTRATE (ONE OF PAIR OF SUBSTRATES), 20 COUNTER SUBSTRATE (ONE OF PAIR OF SUBSTRATES), 30 LIQUID CRYSTAL LAYER, 40 SEAL PORTION, 100A, 100B, 100C LIQUID CRYSTAL DISPLAY DEVICE, 240 SMARTPHONE (ELECTRONIC DEVICE), 250 FLAT-SCREEN TV (ELECTRONIC DEVICE), 270 LAPTOP COMPUTER (ELECTRONIC DEVICE), 280 MOBILE ELECTRONIC DEVICE (ELECTRONIC DEVICE)

1. A liquid crystal display device comprising:
a pair of substrates,
a negative liquid crystal layer held between the pair of substrates,
a seal portion held between the pair of substrates and disposed around the liquid crystal layer, and
a pair of alignment layers each of which is disposed on a surface, adjacent to the liquid crystal layer, of a corresponding one of the substrates, wherein
the negative liquid crystal layer comprises a liquid crystal composition including a compound having a functional group represented by formula (A) below,
the seal portion includes a radical polymerization initiator,
the alignment layers comprise a polymer including polyimide,
the polyimide is prepared from polyamic acid as a precursor, and
an imidization ratio of polyimide is not less than 60% with respect to the whole polymer, 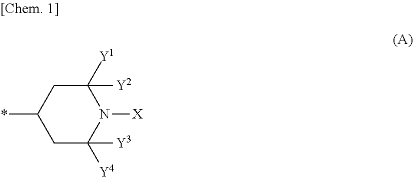
(where X denotes an oxygen radical (O.), a hydroxyl group, a C₁₋₂₀ linear alkyl group, or a C₃₋₂₀ branched alkyl group, and
Y1 to Y4 each independently denote a C₁₋₄ linear alkyl group or a C₃₋₄ branched alkyl group).

2. A liquid crystal display device comprising:
a pair of substrates,
a negative liquid crystal layer held between the pair of substrates,
a seal portion held between the pair of substrates and disposed around the liquid crystal layer, and
a pair of alignment layers each of which is disposed on a surface, adjacent to the negative liquid crystal layer, of a corresponding one of the substrates, wherein
the liquid crystal layer comprises a liquid crystal composition including a compound having a functional group represented by formula (A) below,
the seal portion includes a radical polymerization initiator,
the alignment layers each include a lower alignment layer comprising a polymer including polyimide, and an upper alignment layer disposed in contact with the lower alignment layer to cover the surface of the lower alignment layer,
the polyimide is prepared from polyamic acid as a precursor,
the upper alignment layer comprises polysiloxane, and
a proportion of the polysiloxane is not less than 10 mass % and not more than 30 mass % of an entirety of the alignment layers, 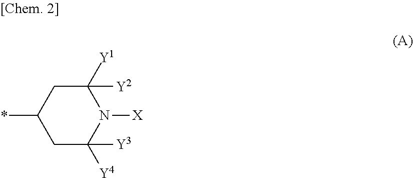
(where X denotes an oxygen radical (O.), a hydroxyl group, a C₁₋₂₀ linear alkyl group, or a C₃₋₂₀ branched alkyl group, and
Y1 to Y4 each independently denote a C₁₋₄ linear alkyl group or a C₃₋₄ branched alkyl group).

3. A liquid crystal display device comprising:
a pair of substrates,
a negative liquid crystal layer held between the pair of substrates,
a seal portion held between the pair of substrates and disposed around the liquid crystal layer, and
a pair of alignment layers each of which is disposed on a surface, adjacent to the liquid crystal layer, of a corresponding one of the substrates, wherein
the liquid crystal layer comprises a liquid crystal composition including a compound having a functional group represented by formula (A) below,
the seal portion includes a radical polymerization initiator,
the alignment layers each include a lower alignment layer comprising a polymer including polyimide, and a surface treatment layer disposed in contact with the lower alignment layer to cover the surface of the lower alignment layer,
the polyimide is prepared from polyamic acid as a precursor,
the surface treatment layer comprises a silane coupling agent, and
the silane coupling agent has a functional group forming a covalent bond with a carboxyl group present in the polyamic acid, 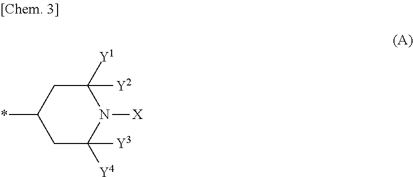
(where X denotes an oxygen radical (O.), a hydroxyl group, a C₁₋₂₀ linear alkyl group, or a C₃₋₂₀ branched alkyl group, and
Y1 to Y4 each independently denote a C₁₋₄ linear alkyl group or a C₃₋₄ branched alkyl group).

4. The liquid crystal display device according to claim 3, wherein the silane coupling agent is a compound represented by formula (D) below:
[Chem. 4]
R₃Si—Z (D)
(where R denotes a chlorine atom or a C₁₋₄ alkoxy group, and Z denotes a substituent represented by any of formulae (D1) to (D19) below:) 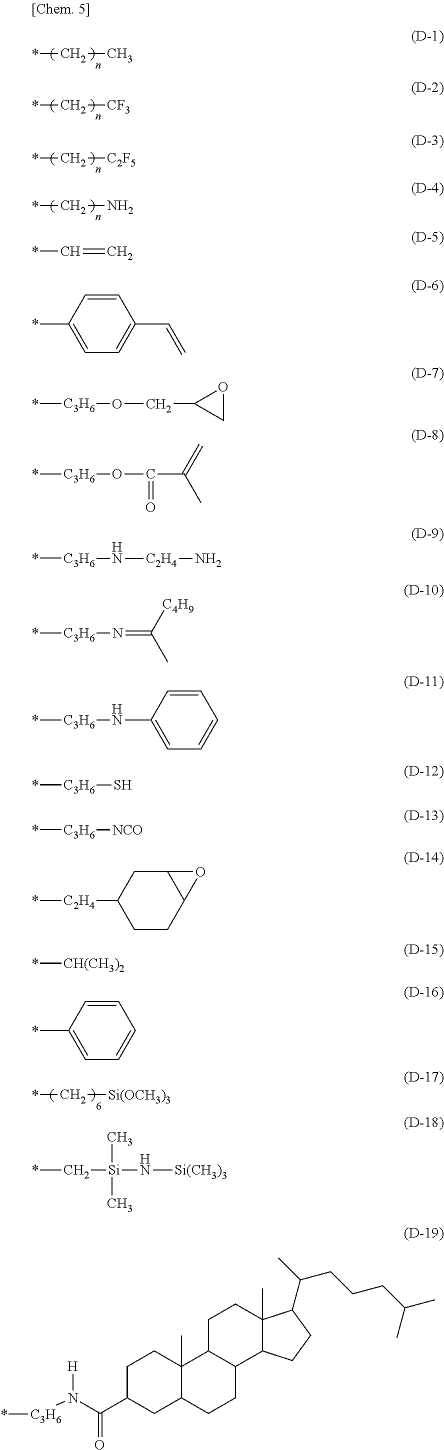
(where n denotes an integer of 1 to 18).

5. The liquid crystal display device according to claim 4, wherein the silane coupling agent is a compound represented by formula (109) below:

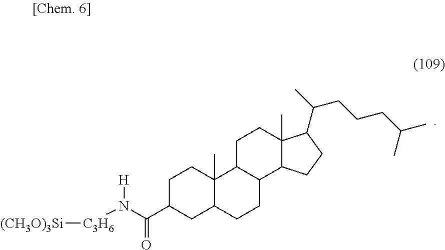

6. The liquid crystal display device according to claim 2, wherein an imidization ratio of the polyimide is not less than 45% with respect to the whole polymer.

7. The liquid crystal display device according to claim 1, wherein a content of the compound in the liquid crystal layer is not more than 1000 ppm.

8. The liquid crystal display device according to claim 1, wherein the liquid crystal composition includes a liquid crystal molecule having a functional group represented by formula (B) below: 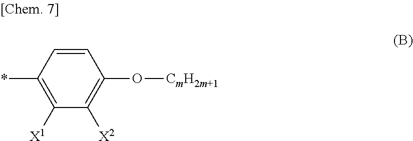
(where X1 and X2 each independently denote a hydrogen atom, a fluorine atom, and
m denotes an integer of 1 to 18).

9. The liquid crystal display device according to claim 1, wherein the liquid crystal composition includes at least one compound selected from the group consisting of formulae (C1) to (C4) below: 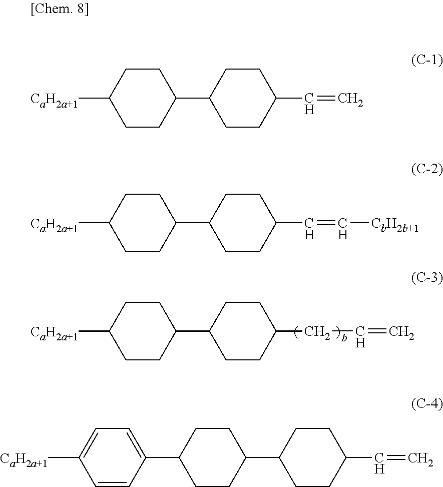
(where a and b each independently denote an integer of 1 to 6).

10. The liquid crystal display device according to claim 1, wherein the radical polymerization initiator is decomposed by absorbing light with a wavelength of not less than 350 nm.

11. The liquid crystal display device according to claim 1, wherein the radical polymerization initiator has a thermal decomposition temperature of not less than 50° C.

12. An electronic device comprising the liquid crystal display device described in claim 1.
